(19) United States
(12) Patent Application Publication
(10) Pub. No.: US 2026/0049929 A1
(43) Pub. Date: Feb. 19, 2026

(54) SYSTEM AND METHOD FOR PHASE CHANGE MATERIAL ANALYSIS

(71) Applicant: SUNAMP LIMITED, East Lothian (GB)

(72) Inventors: Gylen ODLING, East Lothian (GB); Kate FISHER, East Lothian (GB); David OLIVER, East Lothian (GB)

(21) Appl. No.: 19/128,387

(22) PCT Filed: Nov. 10, 2023
(86) PCT No.: PCT/GB2023/052952

§ 371 Date: May 8, 2025

(30) Foreign Application Priority Data
Nov. 10, 2022 (GB) 2216795.1

(51) Int. Cl. G01N 21/41; G01N 21/17

(52) U.S. Cl. CPC G01N 21/4133; G01N 2021/1761; G01N 2021/414

(57) ABSTRACT

The present invention discloses a system, apparatus and method for analysing the contents of a phase change material. More specifically, the present invention discloses an apparatus for analysing the compositions of PCMs, as well as blends of anhydrous salts and blends of organic PCMs by their refractive indices.

### Field of the Invention

The present invention relates to a system and method for the analysis of phase change materials. More specifically, the present invention relates to a system and method for the analysis of phase change materials using their refractive index (RI).

### BACKGROUND OF THE INVENTION

Phase change materials (PCMs) are energy storage media which use the energy absorbed and released on a phase change, such as a phase change between solid and liquid phases, liquid and gas phases, solid and gas phases, or from one solid phase to another solid phase as an energy storage mechanism.

PCMs may be organic such as paraffins, fats, oils and various esters, or inorganic, such as salts, solutions of salts in water, and inorganic salt hydrates.

Inorganic salts hydrates are often selected for energy storage applications due to their low cost, non-combustibility and high energy storage capacity. Such materials comprise a salt which is crystallised with one or more molar equivalents of water in the crystal lattice.

Anhydrous salts are also often selected as PCMs due to their high phase transition temperatures, which may be higher than that of salt hydrates and organic PCMs. Anhydrous salts may exhibit phase transition temperatures above 100° C., above 150° C., above 200°° C., above 250° C. or above 300° C.

Organic PCMs may be chosen for their long-term stability and compatibility with common metal components.

The composition of salt hydrate and salt-water eutectic PCMs (i.e. composition indicated by the ratio of salt to water) is a key parameter affecting the thermal performance of the material. Changing this ratio is known to affect the phase transition temperature and the energy storage capacity of the PCM, and may have further effects on the thermal conductivity and cycle stability of the PCM. Determination and optimisation of the salt concentration in water is therefore vital to produce well performing PCMs.

Often, the PCM will comprise blends of PCMs. For such blends of PCMs, it is important that the composition of blends comprising more than one component PCM such as, for instance, a plurality of different types of salts, a plurality of anhydrous salts or more than one organic PCMs, is known accurately. Such blends are typically made to alter the phase transition temperature for a specific application, and if such blends are made to an incorrect ratio, the resulting PCM will not perform satisfactorily. Furthermore, a blend of multiple anhydrous salts or organic PCMs may exhibit a higher melting and freezing point than required for a desired application, resulting in the latent heat not being fully accessed and potentially causing problematic unwanted freezing. Clearly, this is an unwanted outcome.

Therefore, to produce a PCM with good performance, the composition should be known to within a high degree of accuracy and precision.

Salt-water eutectics, blended anhydrous salts and salt hydrates used as PCMs are typically highly concentrated in salt content. Various salts have known hydrates comprising less than 60 wt. % water (i.e. more than 40 wt. % salt); and changing the water content by more than about 0.5 wt. % or more than 0.1 wt. % may have a significant effect on the materials properties. Many salt-water eutectics require high concentrations of salt, ranging upwards from about 3 wt. % to about 40 wt. % of the salt in water to produce a desired melting point depression effect on the phase transition of water.

Similarly, blends of organic PCMs or anhydrous salts typically used as PCMs may comprise significant (e.g. more than 1 wt. %) amounts of each component material in the PCM.

Analysis of the relative amounts of such component materials, in particular, is therefore made difficult due to the combination of need for high accuracy as well as the sensitivity to small changes.

This poses a challenging problem, because any analytical method used to analyse the PCM must be sensitive to very small changes in a high concentration of salt or organic PCM components.

Typically, methods may have the required sensitivity or ability to measure high concentrations, but not both. Methods may also require the sample to be altered in an irreversible way, or in a way which is incongruent to the preparation of the PCM, or in a manner which causes a disadvantageous delay in allowing the analysis to be run (e.g. dilution or serial dilution).

Quantification of salt-water eutectic, salt hydrate, blended organic or blended anhydrous salt(s) as the component materials of PCMs is therefore complicated by this relatively high concentration of the PCM components and the aforementioned high degree of accuracy required in its preparation to maximise its performance as a PCM.

For example, sodium acetate trihydrate is a PCM consisting of about 60.3 wt. % sodium acetate in water, and thus, to analyse a PCM comprising sodium acetate trihydrate, small changes in this value need to be measurable.

For many techniques, a dilution or series of dilutions, with an associated error or errors, are necessary to reduce the concentration to a measurable (i.e. non-signal saturating) concentration. Methods such as absorption spectroscopy, flame photometry, inductively-coupled plasma optical emission spectroscopy, mass spectrometry, nuclear magnetic resonance, ion chromatography or electrochemical analytical methods typically suffer from this signal saturation issue. Furthermore, such a regimen involving sampling, dilution and then measurement is slow, may be prone to sampling error or bias, and is likely to be destructive, and may cause the sample to be unable to be returned to the PCM and thereby causes wastage.

It has been found by the inventors that many techniques, such as conductivity, speed of sound, titration, optical emission spectrometry, mass spectrometry, ion selective electrodes and pH may be applied, however these techniques fail either in the resolution, sensitivity, accuracy and precision required. Due to the high component (e.g. more than 1 wt. %, 5 wt %, 10 wt. %, 20 wt. %, 30 wt. %, 40 wt. % or 50 wt. % of the component) concentrations used in PCMs, the responses of these techniques become saturated, and therefore become insensitive to change, at component concentrations less than those concentrations used in the desired PCM composition. Therefore, these techniques have been found to be non-functional in the analysis of PCMs without employing dilution or serial dilution and thereby incurring the aforementioned problems.

The methods of the prior art that have been investigated by the inventors include conductivity, speed of sound, pH and thermogravimetry. However, several drawbacks have been identified for each of these prior art methods as will be discussed below:

Conductivity and speed of sound measurement typically do not exhibit the required accuracy, due to saturation of the measurement at the concentrations of concern for PCMs. FIG. 3 shows an example of the speed of sound in sodium acetate solutions saturating at around 35 wt. % sodium acetate. Therefore, to analyse a solution of higher concentration than 35% wt is not possible using these methods.

pH measurements are known to the inventors to be useful as a general guide, however for accuracy of determining the concentration, the pH measurement method lacks sensitivity, due both to the pH converging on the pH of the salt hydrate (for example, about 8-9 for sodium acetate) at low concentrations (e.g. about 5 wt. %) and also to the limitations on the accuracy and precision with which pH can be measured.

Thermogravimetry has been applied successfully by the inventors to determine water content, where highly accurate results can be obtained, however due to the requirement to dry the sample for an extended period of time, the thermogravimetry method is impractical for extensive use. Typically, thermogravimetry of a large enough sample to be representative of the whole may take several days to fully dry, at which point a reliable answer can be obtained, however it is preferable to know the composition rapidly, or ideally in real time. This is particularly true when producing high volumes of PCM, where the PCM or device containing the PCM may be transferred off site before thermogravimetric analysis returns a result.

Density is a means by which PCMs may be analysed, with solutions existing that allow sufficiently high accuracy, precision and resolution of measurement of salt concentration. However, the means by which density are measured to these high standards is disadvantageous for PCM analysis. To achieve the required accuracy, precision and resolution, Coriolis mass flow measurements are needed. This involves passing the PCM through an oscillating or vibrating tube, i.e. a moving part, and measuring the resulting change in frequency of oscillation. The presence of moving parts represents a failure mode which is made significantly worse by the propensity of the PCM to freeze if not maintained at a sufficiently high temperature, it also causes difficulties in ensuring this temperature is maintained along the whole of the moving parts of the measurement device.

Vibrations or oscillations of this nature cause any cooled PCM to rapidly crystallise, and in doing so cause damage to the measurement unit. Furthermore, PCMs often involve the inclusion of insoluble additives such as nucleation agents, which may cause inconsistencies or noise in the measurement of density by this method.

The speed of which a result is returned is also a key parameter for any analytical technique. An ideal technique gives an accurate result in real time, causing no or only minimal slowing of the preparation process. As discussed, any method which involves sampling and dilution slows the process considerably, and causes the potential for real-time (i.e. instantaneous) analysis to be lost.

Thermogravimetry has been found by the inventors to have the required accuracy and precision to be used to analyse salt hydrate PCMs, however the need for sampling and the long times required to dry samples of volume significant enough to give the desired accuracy and precision causes this method to be very slow, on the order of hours or days.

It is an object of the present invention to mitigate or obviate one or more of the aforementioned problems.

It is an object of the present invention to provide a system and an apparatus that may be used to determine the composition of a PCM and in particular, the composition of a multiple component PCM (e.g. PCM comprising multiple components comprising anhydrous salt(s) and/or solutions of salt(s) and/or organic Phase Change materials).

It is an object of the present invention to provide a system and an apparatus that may be used to determine the composition of a PCM, where the PCM comprises a PCM component at high concentration (e.g. above 1 wt. %). A high concentration of a constituent component of a PCM is considered herein to be a concentration above about 1 wt. %.

It is an object of the present invention to provide a system and an apparatus that can determine the composition of a PCM comprising two or more component PCM materials, where each component is present in an amount between 1 and 99 wt. % and can be measured with an accuracy to within less than 0.5 wt. % or preferably less than 0.1 wt. %.

Herein the term,“component” is to be understood to mean one of the constituent parts of the PCM, for example a salt, salt hydrate, organic PCM. Water may also be a component.

“Component” as defined herein may be selected from any one or more of the following group:
Anhydrous salts;
Hydrated salts;
Organic materials, and
Water.

It is an object of the present invention to provide a system and an apparatus that can determine the composition of a PCM comprising between 1 and 99 wt. % of one or more components selected from a list comprising of;
Group I and II carboxylate salts;
Group I and II nitrate salts;
Group I and II chloride salts;
Group I and II bromide salts;
Group I and II sulfate salts;
Group I and II phosphate salts;
Group I and II tetrafluoroborate salts;
Alkylammonium salts of carboxylates, phosphates, nitrates, and/or halides; and Optionally water.

In particular, it is an object of the present invention to provide a system and an apparatus that can determine the composition of a PCM comprising between 40 and 75 wt. % of one or more components selected from a list comprising of;
Group I and II carboxylate salts;
Group I and II nitrate salts;
Group I and II chloride salts;
Group I and II bromide salts;
Group I and II sulfate salts;
Group I and II phosphate salts;
Group I and II tetrafluoroborate salts;
Alkylammonium salts of carboxylates, phosphates, nitrates, and/or halides; and Optionally water.

It is also an object of the present invention to provide a system and an apparatus that can determine the composition of a PCM comprising between 40 and 75 wt. % of one or more salts selected from a list comprised of;
Sodium acetate
Sodium sulfate
Calcium nitrate
Magnesium nitrate
Lithium nitrate
Calcium chloride
Calcium bromide
Strontium bromide; and water.

It is an object of the present invention to provide a system and an apparatus that can determine the composition of PCMs comprising; any one or more of the following salts in a concentration in the range indicated as follows:
About 50-65 wt. % sodium acetate;
About 45-60 wt. % sodium sulfate;
About 65-75 wt. % calcium nitrate;
About 50-65 wt. % magnesium nitrate;
About 50-60 wt. % lithium nitrate;
About 45-55 wt. % calcium chloride;
About 60-70 wt. % calcium bromide;
or
About 65-75 wt. % strontium bromide;
and water to balance to 100% w/w; to within less than 0.5 wt. %, or preferably less than 0.1 wt. % of the selected salt in water.

It is an object of the present invention to provide a system and an apparatus that can determine the composition of salt-water eutectic PCMs comprising any one or more of the following salts in a concentration in the range indicated as follows:
Between 10 and 30 wt. % MgSO₄;
Between 20 and 40 wt. % Mg(NO₃)₂;
Between 10 and 30 wt. % MgCl₂;
Between 10 and 35 wt % CaCl₂;
Between 20 and 50 wt % Ca(NO₃)₂;
Between 30 and 50 wt % SrBr₂;
Between 3 and 50 wt % NaBr;
Between 5 and 25 wt % NaCl;
Between 1 and 10 wt % Na₂SO₄;
Between 15 and 25 wt % NH₄Cl;
Between 10 and 25 wt % KCl;
Between 25 and 45 wt % K₂CO₃;
Between 20 and 40 wt % NaH₂PO₄;
Between 10 and 40 wt % NaOAc;
Between 10 and 35 wt % NaOOCH;
Between 10 and 30 wt % Na₂CO₃;
Between 10 and 35 wt % LiCl;
Between 30 and 60 wt % ZnCl₂;
Between 20 and 40 wt % FeCl₃;
Between 20 and 40 wt % CuCl₂;
Between 20 and 40 wt % of BaCl₂;
Between 10 and 25 wt % KHCO₃;
Between 20 and 40 wt % Li-, Na- and/or K-benzoate;
Between 20 and 50 wt % Li-, Na- and/or K-glycolate;
Between 20 and 50 wt % Li-, Na- and/or K-glycinate;
Between 20 and 50 wt % Li-, Na- and/or K-propionate;
Between 20 and 50 wt % Li-, Na- and/or K-β-Alaninate;
Between 20 and 50 wt % Li-, Na- and/or K-Aspartate;
Between 20 and 50 wt % Li-, Na- and/or K-Lactate;
Between 20 and 50 wt % Li-, Na- and/or K-2,2′-bishydroxymethylpropionate;
Between 20 and 50 wt % Li-, Li₂-, Na-, Na₂-, K- and/or K₂-glutamate;
Between 20 and 40 wt % Li-, Li₂-, Na-, Na₂-, K- and/or K₂-adipate; or
Between 20 and 50 wt % Li-, Li₂-, Na-, Na₂-, K- and/or K₂-tartrate;
with the remainder of the composition of the salt-water eutectic PCMs being comprised of water to within less than 0.5 wt. %, or preferably less than 0.1 wt. % of the selected salt in water.

It is an object of the present invention to provide a system and an apparatus that can determine the composition of a PCM comprising a plurality of organic components, each component comprising between 1 and 99 wt. % of the PCM and being selected from a list comprising;
One or more alkyl alcohols,
One or more alkyl carboxylic acids,
One or more paraffins, and/or
One or more polyols.

It is an object of the present invention to provide a system and an apparatus that can determine the composition of a PCM comprising two or more components, wherein the concentration is measured in real time, i.e. instantaneously during preparation.

It is an object of the present invention to provide a system and an apparatus that may be used to make adjustments in real time to the component concentrations to within at least less than 0.5 wt. %, or preferably less than 0.1 wt. %.

It is an object of the present invention to provide a system and an apparatus that ensures that the PCM is retained in a molten state during analysis.

It is an object of the present invention to provide a system and an apparatus that ensures that the PCM has a homogeneous consistency during analysis, is a homogeneous liquid, and/or is a dispersion of solids in a homogeneous liquid.

It is an object of the present invention to provide a method of using an apparatus as disclosed herein to adjust the content of a component forming part of a multiple component PCM to within 0.5 wt. %, or preferably to within 0.1 wt. %.

It is an object of the present invention to provide a system and a method of analysis of a PCM comprising at least two components.

It is an object of the present invention to provide a system and a method of analysis of a PCM comprising more than two components.

It is an object of the present invention to provide a system and an apparatus that can determine the composition of a PCM comprising around 50-65 wt. % sodium acetate in water.

It is an object of the present invention to provide a system and an apparatus that can determine the composition of a PCM comprising sodium acetate in water, wherein the concentration of sodium acetate is around 50-65 wt. % in water, and the resolution required is less than about 0.5 wt. %.

It is an object of the present invention to provide a system and an apparatus that can determine the composition of a PCM comprising sodium acetate in water, wherein the concentration of sodium acetate is around 50-65 wt. % in water, and the resolution required is less than about 0.1 wt. %.

It is an object of the present invention to provide a system and an apparatus that can determine the composition of a PCM comprising sodium acetate in water, wherein the concentration of sodium acetate is about 58-65 wt. % in water, and the resolution required is less than about 0.1 wt. %.

### SUMMARY OF THE INVENTION

The present invention discloses a system, an apparatus and a method for analysis of PCMs including, multiple component PCMs.

Features of the present invention are set forth in the appended claims.

In one aspect of the present invention, there is provided an apparatus for determining the composition of a molten Phase change material (PCM), the PCM comprising any one or more of the following group:
one or more anhydrous salts, each being present in a concentration of at least 1 wt. % of the PCM; an aqueous solution of between about 1 wt. % and 75 wt. % of one or more anhydrous salts; and water; or
one or more organic phase change materials, each being present in the PCM in a concentration of at least 1 wt. % of the PCM;
wherein the apparatus comprises:
means for maintaining the PCM in a molten state;
a reservoir for holding the molten PCM; and
at least one refractometer having a refractive index measurement surface and the refractometer being configured for measuring refractive index of the molten PCM:
at least one means for measuring the temperature of the molten PCM;
and wherein the reservoir is in contact with or in fluid communication with the refractive index measurement surface whereby, in use, the refractometer measures the refractive index of the molten PCM.

In another aspect of the present invention, there is provided an apparatus for determining the composition of a molten Phase change material (PCM), wherein the apparatus comprises:
means for maintaining the PCM in a molten state;
a reservoir for holding the molten PCM; and
at least one refractometer having a refractive index measurement surface and the refractometer being configured for measuring refractive index of the molten PCM:
at least one means for measuring the temperature of the molten PCM;
and wherein the reservoir is in contact with or in fluid communication with the refractive index measurement surface whereby, in use, the refractometer measures the refractive index of the molten PCM.

Preferably, the PCM may comprise any one or more of the following group:
one or more anhydrous salts, each being present in a concentration of at least 1 wt. % of the PCM;
an aqueous solution of between about 1 wt. % and 75 wt. % of one or more anhydrous salts; and water; or
one or more organic phase change materials, each being present in the PCM in a concentration of at least 1 wt. % of the PCM.

In one embodiment, the present invention provides an apparatus for determining the composition of a Phase Change material (PCM) including multiple component molten Phase change material (PCM), the PCM comprising:
A plurality of anhydrous salt components, each anhydrous salt having a concentration of at least 1 wt. %; or
An aqueous solution of between about 1 wt. % and 75 wt. % of one or more salt components;
or
A plurality of organic phase change material components, each organic phase change material component having a concentration of at least 1 wt. %;
wherein the apparatus comprises a reservoir for holding the PCM in a molten state; means for maintaining the PCM in a molten state; and
At least one refractometer having a refractive index (RI) measurement surface and the refractometer being configured for measuring refractive index of the molten PCM,
At least one means for measuring the temperature the temperature of the molten PCM;
And wherein the PCM is in fluid communication with the refractive index measurement surface whereby the refractometer measures the refractive index of the molten PCM.

Herein the term, “reservoir” is to be understood to refer to means for defining a volume of Phase Change Material (PCM). The reservoir may be, or substantially comprise, any containment means such as a containment vessel for instance, a container, one or more tank(s), drum(s) and/or pool(s). The reservoir for the molten PCM may also be, or substantially comprise, a conduit such as a pipe or plurality of pipes for transporting or holding the molten PCM.

Herein, the term “predetermined value” refer to a value in wt % indicating the composition of a component of a PCM composition or of a PCM composition that has a desired composition.

In another aspect of the present invention, there is provided a method for determining the composition of a molten Phase change material (PCM) using a refractive index measuring apparatus, the PCM comprising any one or more of the following group:
one or more anhydrous salts, each with a concentration of at least 1 wt. %,
an aqueous solution of between about 1 wt. % and 75 wt. % of one or more anhydrous salts; and water;
or
one or more organic phase change materials, each in a concentration of at least 1 wt. % of the total PCM composition;
wherein the apparatus comprises
means for maintaining the PCM in a molten state;
a reservoir for holding the molten PCM; and
at least one refractometer having a refractive index measurement surface and the refractometer being configured for measuring refractive index of the molten PCM;
at least one means for measuring the temperature the temperature of the molten PCM;
and wherein the reservoir is in fluid communication with the refractive index measurement surface whereby the refractometer measures the refractive index of the molten PCM;
wherein the method comprises;
providing the PCM in a molten state, and
providing fluid contact between the PCM and the refractive index measurement surface.

In another aspect of the present invention, there is provided, a method for determining the composition of a molten Phase change material (PCM) using a refractive index measuring apparatus,
wherein the apparatus comprises
means for maintaining the PCM in a molten state;
a reservoir for holding the molten PCM; and
at least one refractometer having a refractive index measurement surface and the refractometer being configured for measuring refractive index of the molten PCM;
at least one means for measuring the temperature the temperature of the molten PCM;
and wherein the reservoir is in fluid communication with the refractive index measurement surface whereby the refractometer measures the refractive index of the molten PCM;
Wherein the method comprises;
Providing the PCM in a molten state, and
Providing fluid contact between the PCM and the refractive index measurement surface.

Preferably, the PCM comprises any one or more of the following group:
one or more anhydrous salts, each with a concentration of at least 1 wt. %,
an aqueous solution of between about 1 wt. % and 75 wt. % of one or more anhydrous salts; and
water;
or
one or more organic phase change materials, each in a concentration of at least 1 wt. % of the total PCM composition;
Further features of the present invention are set forth in the appended Claims.

Components as defined herein may be selected from any one or more of the following group:
Anhydrous salts;
Hydrated salts;
Organic materials, and
Water

Due to the concentration of each component of a multi-component PCM, which generally may be above 1 wt %, more than 10 wt. %, more than 20 wt. %, more than 30 wt. %, more than 40 wt. % or more than 50 wt. % of the total composition, measurement of such a high concentration of any component with the required accuracy and precision while maintaining a short or instantaneous (i.e. real-time) analysis has been found by the inventors to be extremely problematic using known techniques.

A PCM that can be analysed by the system and method the present invention may be comprised of a plurality of components (e.g. a salt in water, a mixture of two or more salts, a mixture of two or more salts and water, or a mixture of two or more organic materials). The system and method as described herein is used to measure the composition of the PCM, which may be understood as the component concentration, loading of components or ratio of components.

Techniques which are typically used in the art are those which may involve dilution of the PCM sample to bring the component concentration into a measurable range. For example, techniques such as titration, optical emission, mass spectrometry or the use of ion selective electrodes may be used. These methods are disadvantageous to the PCM preparation process as the result is non-instantaneous, slow or delayed in its return due to the sample processing and measurement time. Furthermore, the use of sampling and dilution introduces errors into the analytical method which would need to be minimised to give a reliable result. These methods may also be destructive in nature (i.e. the samples cannot be returned to the PCM mixture after analysis). Methods which do not require dilution, such as thermogravimetry or pH, may also be used to analyse a PCM, however pH lacks the resolution required and thermogravimetry returns a result in too slow a timescale, typically taking many hours or a few days to reach a conclusive result.

The present invention seeks to alleviate the problems of the prior art.

The present invention provides a method by which analysis of component concentration in PCMs can be achieved, using refractometry.

Herein refractive indices are given according to the refraction of light with the wavelength of the sodium D-line (589.3 nm), however, any wavelength of light may be used. The values given for refractive index (RI) here may be converted to any other wavelength with the appropriate correction according to Cauchy's equation or the Sellmeier equation. The sodium D-line is advantageous in the preparation of most PCMs as there are few PCMs which exhibit an absorption at this wavelength. Hence selecting this wavelength is beneficial.

It has been surprisingly discovered by the inventors that refractometry can be used as a method by which analysis of a Phase Change Material (PCM) component of Phase Change Materials (PCMs) can be achieved, wherein the PCM component concentrations more than 1 wt %, preferably more than 10 wt. %, preferably more than 20 wt. %, preferably more than 30 wt. %, preferably more than 40 wt. % and preferably more than 50 wt. % of the PCM composition and the resolution required is greater than about 0.5 wt. %. Other methods of analysis have been investigated by the inventors for this purpose and have been found to be insufficient in terms of accuracy, precision and resolution at the concentrations required for PCMs and in particular, for multiple component PCMs.

Herein, the term, “resolution” is defined as the power of a technique to distinguish between two different values, such as refractive indices, corresponding concentrations or loadings of material in a sample. For example, a resolution of 0.001 means that the technique can resolve values that differ by 0.001 (e.g. 1.300 and 1.301).

The present invention also provides an apparatus for determining the composition of multiple component PCMs comprising means for measuring refractive index (i.e. a refractometer).

According to an aspect of the present invention, the present invention provides an apparatus for determining the composition of a PCM, wherein the apparatus is configured to measure the refractive index of the PCM in the range of between about 1.300 and 1.700 and with a resolution of at least 0.001;

According to an aspect of the present invention, the present invention provides an apparatus for determining the composition of a molten PCM comprising:
A plurality of anhydrous salts, each with a concentration of at least 1 wt. %,
An aqueous solution of between about 1 wt. % and 75 wt. % of one or more salts
or
A plurality of organic phase change materials, each with a concentration of at least 1 wt. %
Wherein the PCM is retained in a molten state, and
Wherein the apparatus comprises:
One or more methods of maintaining the PCM in a molten state
One or more refractometer capable of measuring refractive index in the range of between about 1.300 and 1.700 with a resolution of at least 0.001; and
One or more temperature probes, wherein at least one of the temperature probes is configured to measure the temperature of the molten PCM.
One or more means by which the PCM is flowed over the refractive index measurement surface
Wherein the apparatus is used to adjust the component concentration to a value to within less than 1 wt. %, preferably less than 0.5 wt. %, more preferably 0.1 wt. % of a predetermined value.

In another aspect of the present invention, there is also provided a method for determining the concentration of a molten PCM comprising:
A plurality of anhydrous salts, each with a concentration of at least 1 wt. %
An aqueous solution of between about 1 wt. % and 75 wt. % of one or more salts
or
A plurality of organic phase change materials, each with a concentration of at least 1 wt. %

Retaining the PCM in a molten state, the method comprising the following steps:
(i) determining the concentration of a molten PCM comprising:
A plurality of anhydrous salts, each with a concentration of at least 1 wt. %
An aqueous solution of between about 1 wt. % and 75 wt. % of one or more salts
or
A plurality of organic phase change materials, each with a concentration of at least 1 wt. %
(ii) retaining the PCM in a molten state, and
(iii) providing an apparatus comprising:
One or more means of retaining the PCM in a molten state,
One or more refractometers capable of measuring refractive index in the range of between about 1.300 and 1.700 with a resolution of at least 0.001; and
One or more temperature probes, wherein the at least one temperature probe is configured to measure the temperature of the molten PCM;
One or more means by which the PCM is flowed over the refractive index measurement surface,
Wherein the apparatus is used to adjust the component concentration to a value to within at least 1 wt. %, preferably 0.5 wt. %, more preferably 0.1 wt. % of a predetermined value.

The apparatus of the present invention has the advantages that it is configured to quantify a PCM comprising a plurality of components and the apparatus has the following advantages:
it is usable without requiring addition of any reagents into the PCM; addition of reagents into the PCM may affect performance of the PCM
Gives a result instantaneously (i.e. gives a result in real time)
Gives a linear response to component concentration
It is unaffected, or affected in a quantifiable way, by temperature and pH
It is unaffected, or affected in a quantifiable way, by any insoluble additives used in the PCM composition; and
It is operable with no or minimal moving parts, and thereby avoid potential damage caused by flowing PCM, flowing PCM comprising solid additives, and/or accidental crystallisation of the PCM.

Salts hydrate PCMs which it is advantageous to analyse by the system, apparatus and method of the present invention may preferably be selected from a list comprised of;
Sodium acetate trihydrate;
Sodium sulfate decahydrate;
Calcium nitrate tetrahydrate;
Magnesium nitrate hexahydrate;
Lithium nitrate trihydrate;
Calcium chloride hexahydrate;
Calcium bromide hexahydrate; and
Strontium bromide hexahydrate.

Anhydrous salts, which may form a component of a salt hydrate PCM, or be a component of a blend of a plurality of anhydrous salts, are advantageously analysable by the system, apparatus and method of the present invention, and may be selected from a list comprised of;
Group I and II carboxylate salts,
Group I and II nitrate salts,
Group I and II chloride salts,
Group I and II bromide salts,
Group I and II sulfate salts,
Group I and II phosphate salts,
Group I and II tetrafluoroborate salts, and/or
Alkylammonium salts of carboxylates, phosphates, nitrates, and/or halides
And may be optionally combined with water to form the PCM.

Organic materials, which may form a component of an organic PCM are advantageously analysable by the system, apparatus and method of the present invention, and may be selected from a list comprised of;
One or more alkyl alcohols,
One or more alkyl carboxylic acids,
One or more paraffins, and/or
One or more polyols.

In a PCM, each component is required to be in a specific concentration, loading, or have a specific ratio to one or more other components. Blends of a plurality of organic materials to form a blended organic PCM may require a specific ratio of each organic material to give a PCM with the desired thermal performance. Similarly, blends of anhydrous salts that form a PCM will require similarly specific ratios to ensure that the PCM performs as desired. Salt-water eutectics require that the concentration of the salt component(s) present in the aqueous solution is/are controlled carefully.

Salt hydrates exist as well-defined crystal structures with a specific ratio of the salt component to the water component. However, during preparation, the water content may deviate from these nominal hydration values, as anhydrous material is added, water is lost or added, or other additives are introduced. Thus adjustments must be made. Therefore, when preparing salt-hydrate PCMs, the refractometric method disclosed herein may be used to analyse PCM compositions comprising;
About 50-65 wt. % sodium acetate;
About 45-60 wt. % sodium sulfate;
About 65-75 wt. % calcium nitrate;
About 50-65 wt. % magnesium nitrate;
About 50-60 wt. % lithium nitrate;
About 45-55 wt. % calcium chloride;
About 60-70 wt. % calcium bromide; or
About 65-75 wt. % strontium bromide; and
Water to balance.

By way of non-limiting example. sodium acetate trihydrate is a salt hydrate phase change material comprising about 60 wt. % sodium acetate in water. It is known in the prior art that the salt/water ratio of salt hydrate PCMs is a key parameter which is necessary to control to ensure a high performing material. Altering the salt concentration of sodium acetate trihydrate is known in the prior art to cause a loss of thermal energy storage capacity and the melting transition to occur over a wide range, rather than at the desired temperature of 58° C. Furthermore, an increase in water content causes an increased likelihood of subcooling, the process by which salt hydrates may not crystallise at their phase transition temperature and remain liquid at temperatures below this point. This change in parameters may be disadvantageous to providing a high performance PCM or thermal energy storage device comprising a PCM.

It is disclosed herein that sodium acetate PCM solutions of about 50-65 wt. % sodium acetate may have a refractive index between about 1.390 and 1.410 above about 58° C.

It is disclosed herein that the refractive index of sodium acetate PCM solutions of about 50-65 wt. % sodium acetate have a linear refractive index response with respect to concentration above about 58° C.

It is disclosed herein that the refractive index of sodium acetate PCM solutions of about 50-65 wt. % sodium acetate have a linear refractive index response with respect to concentration between about 58° C. and about 118° C.

It is disclosed herein that the refractive index of sodium acetate solutions of about 50-65 wt. % has a linear refractive index response with respect to temperature above about 58° C.

According to an aspect of the present invention, the present invention provides an apparatus for determining the composition of a PCM, where the PCM comprises:
Between about 50 wt. % and 65 wt. % sodium acetate, and
Water;
Wherein the solution is at a temperature greater than about 58° C.; and
Wherein the apparatus comprises:
One or more methods of maintaining the PCM in a molten state
One or more refractometer(s) capable of measuring refractive index in the range of between about 1.390 and 1.410 with a resolution of at least 0.001; and
One or more temperature probes, wherein at least one measures the temperature of the PCM solution.
One or more means by which the PCM is flowed over the refractive index measurement surface
Wherein the apparatus is used to adjust the salt concentration between 40 wt. % and 75 wt. % to a value to within at least 1 wt. %, preferably 0.5 wt. %, more preferably 0.1 wt. % of a predetermined value.

It is disclosed herein that, depending on the salt selected and concentration range in question, that the refractive index of a salt-hydrate, blend of anhydrous salts or organic materials comprising the PCM is between about 1.3 and 1.7.

Preferably, the salt in hydrated form comprises sodium acetate and the one or more refractometer(s) are capable of measuring refractive index in the range of between about 1.390 and 1.410 with a resolution of at least 0.001.

It has been found by the inventors that the refractometer may have a resolution of at least 0.0005, or preferably at least 0.0001.

It has been found by the inventors that the refractometer may have a resolution of at least 0.0005, or preferably at least 0.0001, when the refractive index is measured between about 1.3 and 1.7.

It has been found by the inventors that the refractometer may have a resolution of at least 0.001, or preferably at least 0.0005, or more preferably at least 0.0001 when the refractive index is measured between about 1.3 and 1.7, and the device is operated above the melting point of at least one component of the PCM.

Thus, a refractometer configured to measure the refractive index of the PCM in the range of between about 1.300 and 1.700 and with a resolution of at least 0.001 is suitable for use in the system, method and apparatus of the present invention. In particular, a refractometer with the aforementioned characteristics is suitable for quantifying the concentration of salts in water at concentrations around that of a salt hydrate composition.

A refractometer with the configured to measure the refractive index of the PCM in the range of between about 1.300 and 1.700 and with a resolution of at least 0.001 may also be used to quantify the concentration, ratio or relative mass loading of one anhydrous salt component in one or a blend of anhydrous salts.

A refractometer configured to measure the refractive index of the PCM in the range of between about 1.300 and 1.700 and with a resolution of at least 0.001 may also be used to quantify the concentration, ratio, or relative mass loading of one organic PCM component in one or a blend of organic PCM components.

In another embodiment of the invention, the apparatus may also comprise;
One or more inlets supplying the PCM component(s) to the refractometer refractive index measurement surface; and
One or more outlets by which the PCM component(s) may flow away from the refractometer.

The inventors have surprisingly found that careful control over the temperature of the refractometer apparatus, but also the PCM solution and therefore the surrounding pipework and instrumentation can be achieved in order to ensure a reliable refractometry measurement.

Furthermore, it has been surprisingly found by the inventors that the homogeneity, dissolution and dispersion of the PCM component(s), as well as any other additives used, can be controlled in order to achieve a reliable refractometry measurement.

Therefore, the present invention also provides means for maintaining the PCM component(s) at a stable and appropriate temperature for refractive index measurement. More specifically, the present invention provides a system, apparatus and method including various means by which the PCM solution may be maintained at a stable and sufficient temperature for refractive index measurement in a temperature region where the solution is fully liquid, and gives a linear relationship between refractive index and temperature, and a linear relationship between refractive index and component concentration.

It is disclosed herein that one or more inlets and/or outlets may optionally comprise;
One or more means for heating and/or cooling PCM flow; and/or
One or more means for thermally insulating the PCM flow; and/or
One or more means for mixing the PCM flow; and/or
One or more means for filtering the PCM flow; and/or
whereby the temperature of the PCM is maintained in a homogeneous, molten state, i.e. is above the melting point of at least one of the PCM components.

Furthermore, using these features, the apparatus of the present invention can be used to measure the composition of a salt hydrate PCM, salt-water eutectic, blend of anhydrous salts or blend of organic PCM components; and the apparatus can be applied to a large volume of PCM, using recirculation of the liquid PCM over the refractive index measurement surface of the apparatus, which can be located on the inlet and outlet of a storage and/or mixing vessel.

It has been discovered by the inventors that hysteresis may cause a problem when using the apparatus of the present invention to measure the composition of PCMs such as sodium acetate solutions. Hysteresis has been found to be observable when the temperature of the PCM changes too rapidly, particularly where a thermal probe with a slow response, or one which is located too far from or is too insulated from the refractive index measurement surface.

Accordingly, the present invention provides an apparatus comprising a thermal probe at a pre-determined location, particularly, a location of a thermal probe in, or substantially measuring, the PCM composition itself. It has been surprisingly found that the apparatus of the present invention comprising the thermal probe at the pre-determined location achieves the technical advantage of avoiding or alleviating the problem of hysteresis.

The thermal probe may be situated in the PCM composition in the vicinity of the refractive index measurement surface by introduction of a port in the container vessel (i.e. pipework) surrounding the refractive index measurement surface through which the thermal probe may be located.

Furthermore, the inventors have surprisingly discovered that a low rate of change of temperature of the PCM composition may be used to alleviate the problem of hysteresis. According to the method of the present invention, a rate of temperature change of less than ±1.0° C. min⁻¹, less than ±0.5° C. min⁻¹ or less than ±0.3° C. min⁻¹ during measurement is provided to avoid or alleviate the problem of hysteresis of the refractive index measurement.

The apparatus and system of the present invention comprises thermally insulating the PCM vessel and/or pipework supplying the PCM to the refractive index measurement surface so that the above rate of change of temperature may be achieved. Further means that may be employed is the use of trace heating and/or cooling. Herein trace heating and/or cooling is defined as the application of heat or cooling over a large surface area. Applying trace heating and/or cooling is disclosed herein to be suitable to ensure a low temperature gradient across the refractive index measurement surface due to the low, dispersed application of the heating and/or cooling, removing the likelihood of hot/cold spots or zones local to the source of heating/cooling which could cause such a temperature gradient.

Combination of trace heating and insulation is disclosed as a preferred embodiment of the present invention.

### DESCRIPTION OF THE FIGURES

FIG. 1 shows the variation in latent heat of a sodium acetate-water PCM on varying the water content between about 39.7 wt. % and 48.7 wt. %; this shows the problems associated with the known systems and the consequence of having poor control over the PCM composition;

FIG. 2 shows the sodium acetate-water phase diagram for the composition shown in FIG. 1;

FIG. 3 shows the problems and limitations of the current systems, for instance, by using conductivity and speed of sound measurement-the temperature is at 70° C.; in particular, FIG. 1 shows the saturation of the response of a speed of sound probe when applied to different concentrations of sodium acetate solution;

FIG. 4 shows the refractive index response of a refractometer when applied to a 60 wt. % solution of sodium acetate between 60° C. and 80° C. using the apparatus in an embodiment of the present invention;

FIG. 5 shows the refractive index response of a refractometer when applied to a 59 wt. % solution of sodium acetate between 60° C. and 80° C. using the apparatus in an embodiment of the present invention;

FIG. 6 shows the refractive index response of a refractometer when applied to a 58 wt. % solution of sodium acetate between 60° C. and 80° C. using the apparatus in an embodiment of the present invention;

FIG. 7 shows the refractive index response of a refractometer when applied to a 57 wt. % solution of sodium acetate between 60° C. and 80° C. using the apparatus in an embodiment of the present invention;

FIG. 8 shows the refractive index response of a refractometer when applied to a PCM comprising approximately 59 wt. % sodium acetate and a polymer according to WO2014195691A1 between 60° C. and 80° C. using the apparatus in an embodiment of the present invention;

FIG. 9 shows the refractive index response of a refractometer when applied to a PCM comprising approximately 59 wt. % sodium acetate, a polymer according to WO2014195691A1, and about 1.9 wt. % disodium phosphate dihydrate between 60° C. and 80° C. using the apparatus in an embodiment of the present invention;

FIG. 10 shows an embodiment of the apparatus of the present invention comprising a refractometer located in a vessel containing a PCM in accordance with the present invention;

FIG. 11 shows an embodiment of the apparatus of the present invention with a refractometer located in a pipe in accordance with the present invention;

FIG. 12 shows hysteresis of the refractive index against temperature in accordance with the present invention;

FIG. 13 shows an embodiment of the apparatus of the present invention, showing the use of heating and/or cooling jackets and/or insulation on a pipe fitted with a refractometer in accordance with the present invention;

FIG. 14 shows the hysteresis of refractive index in a heating and cooling trace where the rate of change of temperature is about 1.2° C. min⁻¹ in accordance with the present invention;

FIG. 15 shows a lack of hysteresis of refractive index in a heating and cooling trace where the rate of change of temperature is about 0.3° C. min⁻¹ in accordance with present invention;

FIG. 16 shows various thermal probe locations which may be used in the apparatus of the present invention;

FIG. 17 shows an embodiment of the apparatus of the present invention including PCM preparation set-up and comprising a refractometer apparatus, where the apparatus inlet and/or outlet is modified with various equipment; and

FIG. 18 shows the spread of thermal performance of PCMs prepared with and without the apparatus of the present invention; the advantage of the apparatus and method of the present invention in controlling the composition of the PCMs is apparent;

FIG. 19 shows a process flow describing the method in accordance with the present invention, including use of the apparatus of the present invention, comprising a refractometer for PCM composition analysis and adjustment;

FIG. 20 shows example data for RI windows corresponding to acceptable compositions (e.g. to less than 1 wt. % accuracy of calcium nitrate content) of a predetermined composition of a calcium nitrate tetrahydrate based PCM in accordance with the present invention; and

FIG. 21 shows example data for RI windows corresponding to acceptable compositions (e.g. to less than 1 wt. % accuracy of tetrabutylammonium hydroxide content) of a predetermined composition of a tetrabutylammonium hydroxide based PCM in accordance with the present invention.

### DETAILED DESCRIPTION

Salt hydrates, blends of anhydrous salts, salt-water eutectics and blends of organic PCM components may be applied as phase change materials (PCMs) for thermal energy storage applications. Their high latent heats and low costs are advantageous for this purpose. However, in preparing a PCM of these types, it is required to know to a high degree of accuracy the concentration of the various PCM components present in the PCM preparation. Changing the ratio of PCM components can have significantly effects on the characteristics and performance of the material, including its melting point, energy storage capacity, stability to repeated thermal cycles and propensity to subcool. It is typical for there to exist an optimum ratio of components for each PCM. This may be an integer molar ratio (i.e. a trihydrate, hexahydrate, tetrahydrate or similar salt hydrate PCM), may be between such (i.e. a 2.5 hydrate, 3.3 hydrate, 5.9 hydrate), may be an optimum mixture of anhydrous salts or organic PCM components giving a desired phase transition temperature (e.g. 10:90, 20:80, 30:70, 40:60, 50:50 or other mass ratio), or may be a specific eutectic composition of salt(s) in water.

The system, apparatus and method of the present invention for measuring the composition of PCMs is therefore beneficial in the preparation of performance optimised PCMs and PCM containing thermal energy storage devices. Further benefits of the system, apparatus and method of the present invention include process quality control, quality assurance and validation of new materials and methods.

The present invention provides a system, apparatus and method for measuring the concentration of a salt in water accurately, at the concentrations required for most multiple component PCMs to form.

Herein a component is taken to mean one of the constituent parts of the PCM, for example a salt, salt hydrate, or organic PCM. Water may be one component.

Anhydrous salts, which may form a component of a salt hydrate PCM, salt-water eutectic PCM, or be a component of a blend of a plurality of anhydrous salts, are advantageously analysable by the system, apparatus and method of the present invention, and may be selected from a list comprised of;
Group I and II carboxylate salts,
Group I and II nitrate salts,
Group I and II chloride salts,
Group I and II bromide salts,
Group I and II sulfate salts,
Group I and II phosphate salts,
Group I and II tetrafluoroborate salts, and/or
Alkylammonium salts of carboxylates, phosphates, nitrates, and/or halides
And may be optionally combined with water to form the PCM.

Where such salts are to be used as salt-water eutectics, specific amounts of each salt should be present in water to give a single phase transition over a narrow temperature range. Examples of salt-water eutectics are shown in Table 1.

TABLE 1
Salt-water eutectic compositions

| Salt | Eutectic composition in water | |
|---|---|---|
| Sodium sulfate | 3.5 | wt. % |
| Sodium potassium tartrate | 5 | wt. % |
| Magnesium sulfate | 19 | wt. % |
| Potassium chloride | 19.5 | wt. % |
| Ammonium chloride | 18.6 | wt. % |
| Sodium formate | 24.0 | wt. % |
| Strontium chloride | 19.5 | wt. % |
| Sodium nitrate | 35 | wt. % |
| Sodium acetate | 27 | wt. % |
| Sodium chloride | 22.4 | wt. % |
| Lithium nitrate | 24.5 | wt. % |
| Sodium bromide | 39 | wt. % |
| Strontium bromide | 41 | wt. % |
| Magnesium nitrate | 29.9 | wt. % |

Organic materials, which may form a component of an organic PCM are advantageously analysable by the system, apparatus and method of the present invention, and may be selected from a list comprised of;
One or more alkyl alcohols,
One or more alkyl carboxylic acids,
One or more paraffins, and/or
One or more polyols.

A multi-component PCM may be a salt-hydrate PCM. It is often the case that a salt hydrate PCM may comprise more than 40 wt. % salt in water. It has been surprisingly discovered by the inventors that noticeable differences in performance can become apparent when the salt/water content varies by as little as 0.5 wt. %, and may be apparent at lower variations (e.g. 0.1 wt. %).

Salt hydrate PCMs may comprise more than 40 wt. % salt, more than 50 wt. % salt, more than 60 wt. % salt or more than 70 wt. % salt in water. At every concentration, variations of salt concentration by less than 0.5 wt. %, or less than 0.1 wt. % can be significant to the performance of the PCM.

According to the present invention, salts hydrate PCMs which can be advantageously analysed by the system, apparatus and method of the present invention may preferably be selected from a list comprised of;
Sodium acetate trihydrate;
Sodium sulfate decahydrate;
Quaternary ammonium salt clathrates;
Quaternary phosphonium salt clathrates;
Calcium nitrate tetrahydrate;
Magnesium nitrate hexahydrate;
Lithium nitrate trihydrate;
Calcium chloride hexahydrate;
Calcium bromide hexahydrate; and
Strontium bromide hexahydrate.

The nominal salt concentration in water of the aforementioned salts are given in Table 2.

TABLE 2
Salt hydrate compositions

| | Approx. salt | Phase change |
|---|---|---|
| | concentration | temperature |
| Salt hydrate | (wt. % in water) | (° C.) |
| Sodium acetate trihydrate | 60 | 58 |
| Sodium sulfate decahydrate | 55 | 32 |
| Calcium nitrate tetrahydrate | 70 | 43 |
| Magnesium nitrate hexahydrate | 58 | 89 |
| Lithium nitrate trihydrate | 56 | 30 |
| Calcium chloride hexahydrate | 51 | 28 |
| Calcium bromide hexahydrate | 65 | 34 |
| Strontium bromide hexahydrate | 69 | 88 |

During preparation, the water content may deviate from these nominal integer hydrates, as anhydrous material is added, water is lost or added, or other additives are introduced, and adjustments can then be made.

Therefore, the system, apparatus and refractometric method disclosed herein may be used to analyse PCM compositions comprising;
About 50-65 wt. % sodium acetate;
About 45-60 wt. % sodium sulfate;
About 65-75 wt. % calcium nitrate;
About 50-65 wt. % magnesium nitrate;
About 50-60 wt. % lithium nitrate;
About 45-55 wt. % calcium chloride;
About 60-70 wt. % calcium bromide; or
About 65-75 wt. % strontium bromide; and
Water to balance to 100% w/w.

It is therefore necessary to be able to analyse the water content around these values for each salt hydrate, with a level of resolution which can distinguish between changes in salt concentration of less than 0.5 wt. % or preferably less than 0.1 wt. %. This is due to these small changes having significant effects on the performance, including the thermal energy storage capacity, crystal growth rate, and propensity of the PCM to nucleate.

PCMs may also be comprised of a plurality of salts, each in significant concentrations (e.g. >about 0.1 or 1 wt. %). Where a salt is used as a melting point depression agent, it may be present in larger amounts from about 5 wt. % to 40 wt. %. Examples of salt hydrate PCM eutectics are given in Table 3.

TABLE 3
Salt hydrate phase change materials
with melting point depression agents

| | | Parent salt | Phase |
|---|---|---|---|
| | Melting point | hydrate:melting | transition |
| Parent salt | depression | point depression | temperature |
| hydrate | agent | agent (mass:mass) | (° C.) |
| Sodium acetate | Sodium nitrate | 87:13 | 50 |
| trihydrate | | | |
| Calcium nitrate | Sodium nitrate | 94:6 | 36 |
| tetrahydrate | | | |
| Magnesium nitrate | Lithium nitrate | 86:14 | 72 |
| hexahydrate | | | |
| Calcium bromide | Calcium chloride | 55:45 | 15 |
| hexahydrate | hexahydrate | | |
| Calcium nitrate | Lithium nitrate | 58:42 | 17 |
| tetrahydrate | trihydrate | | |
| Calcium nitrate | Copper nitrate | 40:30:30 | 10 |
| tetrahydrate | hexahydrate + | | |
| | lithium nitrate | | |
| | trihydrate | | |

Table 3 is simply exemplary and many further examples of melting point depressed salt hydrate PCMs can be found in the literature [Applied Energy 113 (2014) 1525-1561]. Thus, multi-component PCMs comprising a plurality of salts and water may be required to be analysed accurately, precisely, and with high resolution.

In summary, Table 4 shows by way of example only, the PCMs which may be analysed by the apparatus, system and method as disclosed herein and the PCM components which they may comprise.

TABLE 4

| | Anhydrous | Salt | Organic PCM | |
|---|---|---|---|---|
| Class of PCM | salts | hydrates | components | Water |
| Blended | A plurality | No | No | No |
| anhydrous salts | of anhydrous | | | |
| | salts | | | |
| Salt hydrates | No | One or a | No | No |
| | | plurality | | |
| | | of salt | | |
| | | hydrates | | |
| Salt hydrates | No | One or a | No | Yes |
| | | plurality | | |
| | | of salt | | |
| | | hydrates | | |
| Salt hydrates | One or a | No | No | Yes |
| | plurality of | | | |
| | anhydrous | | | |
| | salts | | | |
| Salt hydrates | One or a | One or a | No | No |
| | plurality of | plurality | | |
| | anhydrous | of salt | | |
| | salts | hydrates | | |
| Salt hydrates | One or a | One or a | No | Yes |
| | plurality of | plurality | | |
| | anhydrous | of salt | | |
| | salts | hydrates | | |
| Blended organic | No | No | A plurality of | No |
| PCMs | | | organic PCM | |
| | | | components | |

Thus,
Blended anhydrous salts PCMs may be formed from a plurality of anhydrous salts components.
Salt hydrate PCMs may be formed from one or more of the following group;
One or a plurality of salt hydrate components;
One or a plurality of salt hydrate components and water;
One or a plurality of anhydrous salt components and water;
One or a plurality of salt hydrate components and one or a plurality of anhydrous salt components;
One or a plurality of salt hydrate components and one or a plurality of anhydrous salt components and water.
Blended organic PCMs may be formed from a plurality of organic PCM components.

The risk of not properly quantifying the amount of the various components forming the PCM is a loss of energy, potential lowering of the nucleation propensity of the PCM and alteration and/or broadening of the melting point.

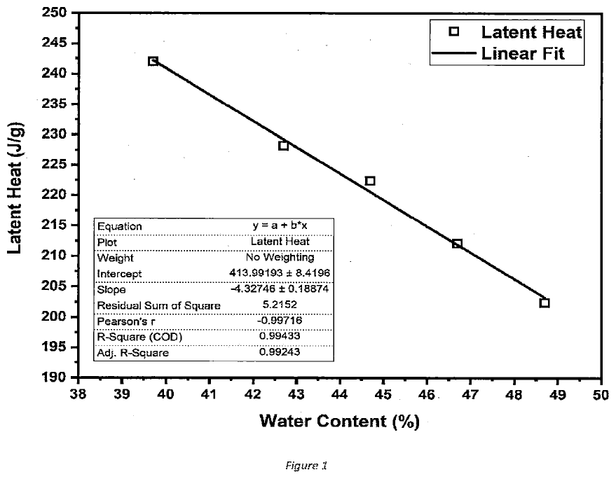

FIG. 1 shows the variation in latent heat of a sodium acetate/water PCM as the water content is varied from the trihydrate composition of about 39.7 wt. % water to a water rich composition of about 48.7 wt. % water. A clear loss of latent heat can be observed on increasing the water content, with each 0.5 wt. % step equating to roughly 2.2 J/g of latent heat lost. Changing the water content by 0.1 wt. % therefore equates to roughly 0.4 J/g of latent heat lost. Therefore, there are benefits to the latent heat of a PCM if the water content can be measured with accuracy and precision.

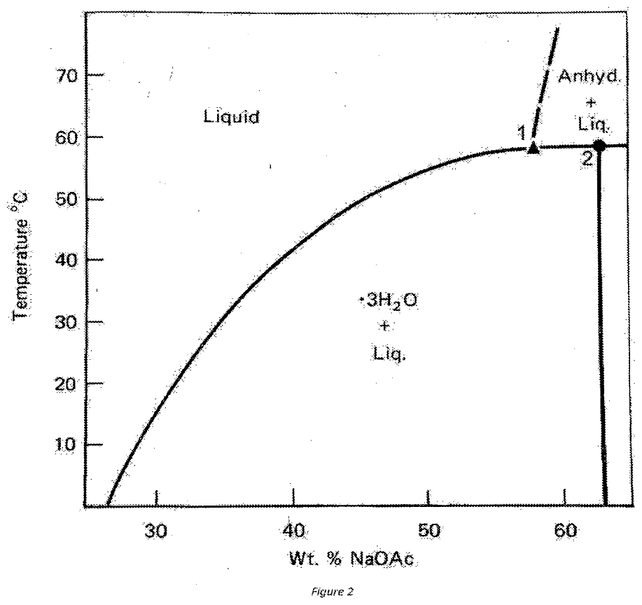

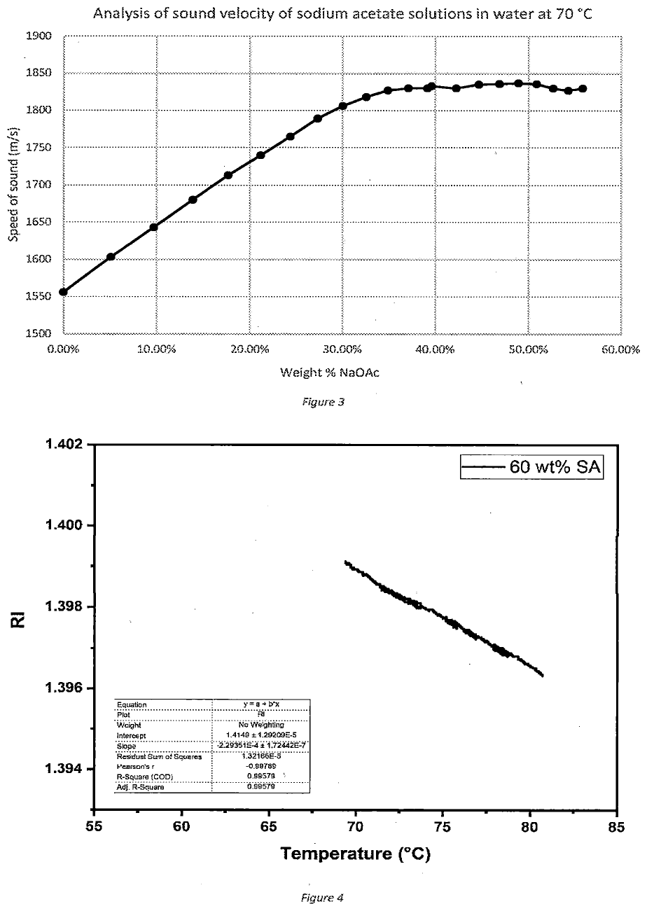

FIG. 2 shows a phase diagram of the sodium acetate/water binary system. It can be observed that around the trihydrate composition (i.e. about 60.3 wt. % sodium acetate and 39.7 wt. % water) that a range of different phases with different melting transition temperatures exist. Thus, changing the water content from around the trihydrate composition has the effect of changing the melting transition temperature from 58° C. Generally, the melting transition is lowered and made broader (i.e. occurring over a wider range of temperatures) by increasing the water content, and raised and made broader by decreasing the water content.

The system, apparatus and method of the present invention, is configured to accurately, precisely and at high resolving power measure the composition of a PCM comprising a plurality of components; and is configured to measure a high concentrations of said components (i.e. more than about 1 wt. %, more than 5 wt. %, more than 10 wt. %, more than 20 wt. %, more than 30 wt. %, more than 40 wt. % or more than 50 wt. %), while also detecting very small variations in this quantity (i.e. less than about 1 wt. %, less than about 0.5 wt. %, or less than 0.1 wt. %).

Sodium acetate trihydrate is typical of salt hydrate PCMs in that it is a concentrated salt solution, being comprised of about 60 wt. % sodium acetate in water, and thus is difficult to analyse accurately and in a timely manner. Therefore, we refer to sodium acetate trihydrate as an example of the salt hydrate PCMs that are the subject of the measuring system, apparatus and method of the present invention, however, the concepts described may be applied to any of the aforementioned PCM composition types (i.e. blended anhydrous salts, salt-water eutectics, blended organic PCM components).

The method of determining high concentrations of any one PCM component in another PCM component accurately, precisely, and rapid or instantaneously, according to the present invention is highly advantageous to the preparation of PCMs and PCM containing devices. For example, measuring the concentration of a salt in water, a salt in another salt or plurality of salts, or an organic material in another organic material or plurality of organic materials.

It has been surprisingly found by the inventors that measurement of refractive index, known as refractometry, is a suitable method by which this may be achieved. Using this method, high concentrations of PCM components, such as sodium acetate, can be quantified in one or more further PCM components, which may include water, to a high degree of accuracy, and small changes in concentration can be resolved.

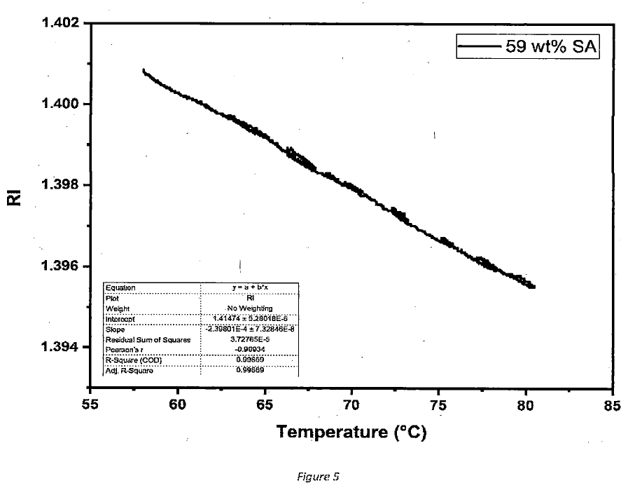

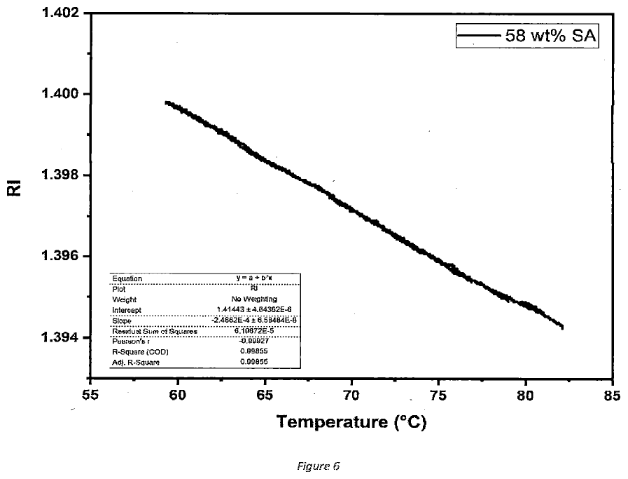

By way of non-limiting example, a refractometer with a resolution of 0.00001 was used to analyse sodium acetate trihydrate solutions. FIGS. 4, 5, 6 and 7 show the refractive index (RI) traces of sodium acetate at various concentrations in water between about 60 and 80° C. Two features are apparent; firstly that the RI trace is linear with changing temperature at each concentration, secondly, that the change in RI is linear with changing concentration at each temperature. In other words, the traces are linear with temperature, and are simply shifted to higher RI by a regular amount on increasing concentration. A further aspect of FIGS. 4-7 is that the amount the traces are shifted to higher RI on increasing concentration is large compared to the precision of the refractometer (i.e. the traces are distinct from one another, much greater than the resolution of the instrument). Thus, according to the system, apparatus and method of the present invention, very small changes in concentration, such as 0.5 wt. % and 0.1 wt. % can be detected, where other means of quantification (e.g. pH, speed of sound, conductivity) would be saturated or poorly responsive.

The refractometer may measure between RI values of about 1.3 and 1.7, between 1.35 and 1.5, between 1.38 and 1.42, or preferably for the example of sodium acetate in water between 1.390 and 1.410.

Where distinction of about 0.5 wt. % or 0.1 wt. % of a PCM component in another PCM component is required, a RI resolution of at least 0.001 is necessary.

Preferably, a resolution of at least 0.0005 may be used. More preferably, a resolution of at least 0.0001 may be used. Therefore, the apparatus used to determine the composition of the PCM should have such a resolution.

The refractometer may measure between RI values of about 1.3 and 1.7, between 1.35 and 1.5, between 1.38 and 1.42, or preferably between 1.390 and 1.410, with a resolution of at least 0.001, 0.0005, or preferably a resolution of at least 0.0001.

Thus, it is disclosed that RI is a suitable method by which the high concentrations of PCM components in multiple component PCMs can be quantified with a high degree of accuracy, where other methods fail.

Where the PCM is a salt-water eutectic or salt hydrate, the apparatus and system disclosed herein may be used to adjust the salt concentration between 3 wt. % and 75 wt. % in water to a value to within 1 wt. %, preferably less than 0.5 wt. %, or more preferably less than 0.1 wt. % of a predetermined value.

The apparatus and system disclosed herein may be used to adjust a plurality of organic phase change material components, each with a concentration of at least 1 wt. % to a value to within 1 wt. %, preferably less than 0.5 wt. %, or more preferably less than 0.1 wt. % of a predetermined value.

The apparatus and system disclosed herein may be used to adjust a plurality of anhydrous salt components, each with a concentration of at least 1 wt. % to a value to within 1 wt. %, preferably less than 0.5 wt. %, or more preferably less than 0.1 wt. % of a predetermined value.

Adjustments to the component concentrations may be made in real-time due to the instantaneous nature of the refractive index measurement.

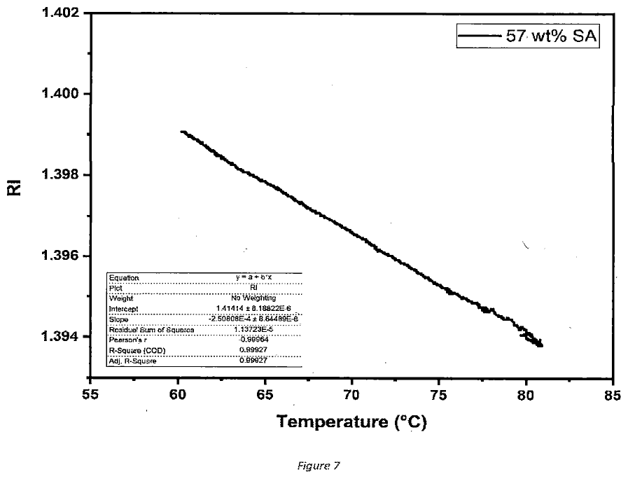

In a further aspect of the present invention, the RI measurement can be calibrated with sufficient accuracy and precision when polymeric additives are included into the PCM composition. FIG. 8 shows an RI trace of a salt hydrate PCM developed by the inventors comprising sodium acetate, water and a polymer according to WO2014195691A1, showing the same linear relationship between RI and temperature.

In a further aspect of the present invention, RI measurements are unaffected by the addition of insoluble additives into the PCM composition. FIG. 9 shows an RI trace of a material developed by the inventors comprising sodium acetate trihydrate, a polymer according to WO2014195691A1, and disodium phosphate (DSP) dihydrate. This overall composition is known to the inventors as SU58 or P58. The RI response to the addition of the disodium phosphate dihydrate is a shift upwards compared to without the additive (i.e. FIG. 8), due to some slight solubility of DSP in the other PCM components, however the trace retains the same gradient and linear characteristics. Thus the apparatus, system and method disclosed herein can be shown to be usable on PCMs comprising a solid dispersed in a molten salt hydrate.

The present invention provides an apparatus comprising a refractometer for use in analysis and in the production of PCM materials.

A refractometer apparatus comprises a refractive index measurement surface, which is defined as the point, area, or plurality thereof at which the refractive index is measured. It may be an optical prism or crystal and may also comprise one or more means for measuring the temperature of the measurement surface and/or the molten PCM in direct contact with the surface. This means for measuring the temperature of the measurement surface and/or the solution in direct contact with the surface may be a thermocouple or thermal probe, which may be situated within the refractometer housing (i.e. be internal to the refractometer and not in direct contact with the PCM). The refractive index measurement surface must be in contact with the PCM solution during operation of the apparatus (i.e. during measurement).

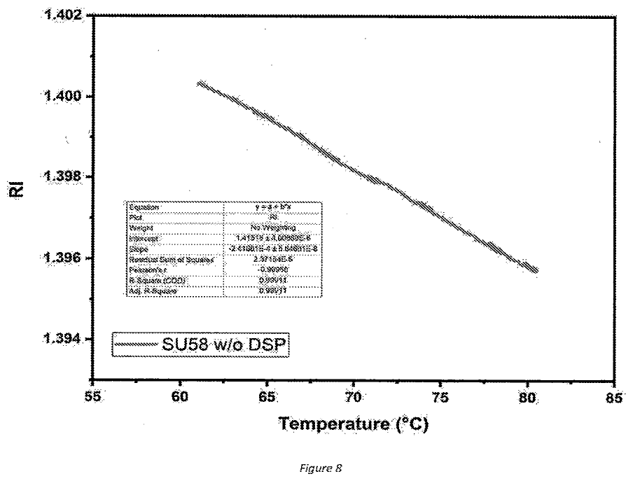

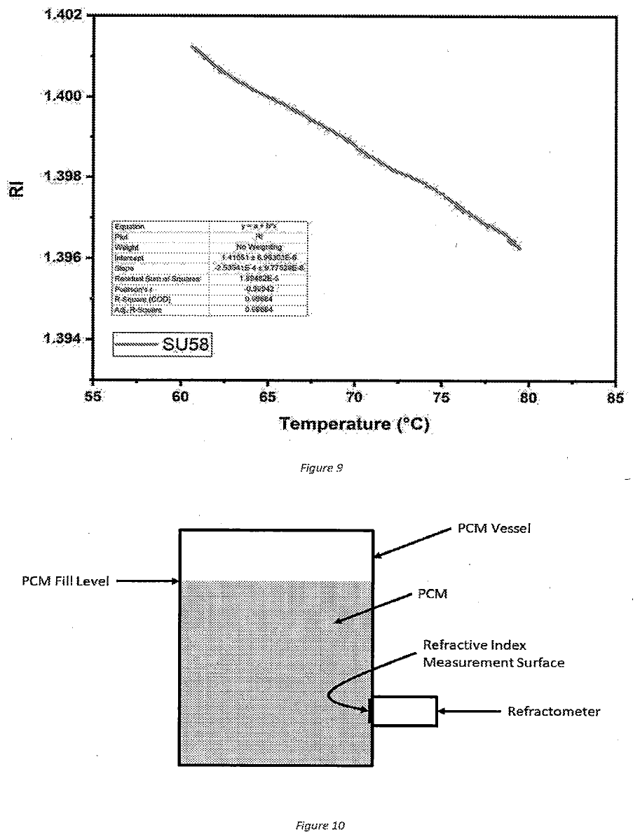

In one embodiment, the apparatus of the present invention comprising a refractometer may be used in a PCM storage or mixing vessel as described in FIG. 10, wherein it is arranged such that the refractive index measurement surface is in contact with the molten PCM in the vessel (i.e. the refractive index measurement surface is below the liquid level of the PCM-the fill level). Preferably, there is a flow of molten PCM over the refractive index measurement surface, and thus the molten PCM in the vessel is agitated, stirred, or otherwise mixed.

In a further embodiment of the present invention, the apparatus comprising a refractometer may be situated externally to a PCM storage or mixing vessel, where a flow of the PCM from the storage or mixing vessel is passed over the refractive index measurement surface of the refractometer.

The refractometer may be heated to above the melting temperature of the PCM to ensure that no crystallisation occurs. The refractometer as a whole may be heated in this manner, or preferably, only the refractive index measurement surface may be heated. Heating may be achieved using trace heating, defined herein as the application of heat over a large area, typically using long resistive heating wires with optional thermal insulation. Alternatively, heat map be supplied by recirculating a heated heat transfer fluid through a heating loop situated around the PCM feed inlet and/or outlet, or around the refractive index measurement surface itself.

The PCM must be maintained in a molten state for analysis to proceed without the risk of crystallisation, which has the potential to cause blockages, and render the analysis unreliable due to deviations from linearity and/or loss of sensitivity to the composition of the bulk. The refractive index measurement depth is small, only analysing the material in direct contact with it, which may give misleading results if the material in contact with it differs from the bulk composition. Crystallisation is one way by which this may occur (i.e. the material crystallised on the refractive index measurement surface differs in composition from the bulk molten liquid). Thus, avoiding crystallisation of the PCM or components thereof is key. For example, the refractometer or refractive index measurement surface may be heated to above 58° C. where the PCM being analysed is sodium acetate trihydrate.

Heat may be applied to the refractive index measurement surface, to the PCM storage or mixing tank, to the flow of PCM being passed over the refractive index measurement surface, or to any pipework circulating PCM. This heat may be used in conjunction with thermal insulation to maintain an even and stable temperature of PCM.

It is a preferred embodiment of the present invention to apply trace heating to the external walls of the pipework and vessel container walls of the apparatus comprising a refractive index measurement surface.

According to a further aspect of the present invention, the refractometer may have one or more inlets supplying the molten PCM, and one or more outlets which flow the molten PCM away from the refractive index measurement surface. For example, the refractometer may be situated in a pipe, or at a junction between one or more pipes. Thus, the flow of PCM solution over the refractive index measurement surface is ensured as shown in FIG. 11. The PCM may flow from one or more PCM storage and/or preparation vessels and may be discharged to a PCM energy storage device directly or flowed into one or more mixing and/or storage vessels, which may be the original preparation vessel(s). It is disclosed herein that the PCM mixing and/or storage vessel to which the inlet is connected may be the same mixing and/or storage vessel into which the outlet feeds. As such, the molten PCM may be recirculated over the refractive index measurement surface. This ensures that the PCM composition being measured by the refractive index measurement surface is representative of the bulk composition of the PCM.

It is disclosed herein that the inlet(s) and/or outlet(s) of such a set up may optionally be modified to ensure the best performance of the refractometer apparatus.

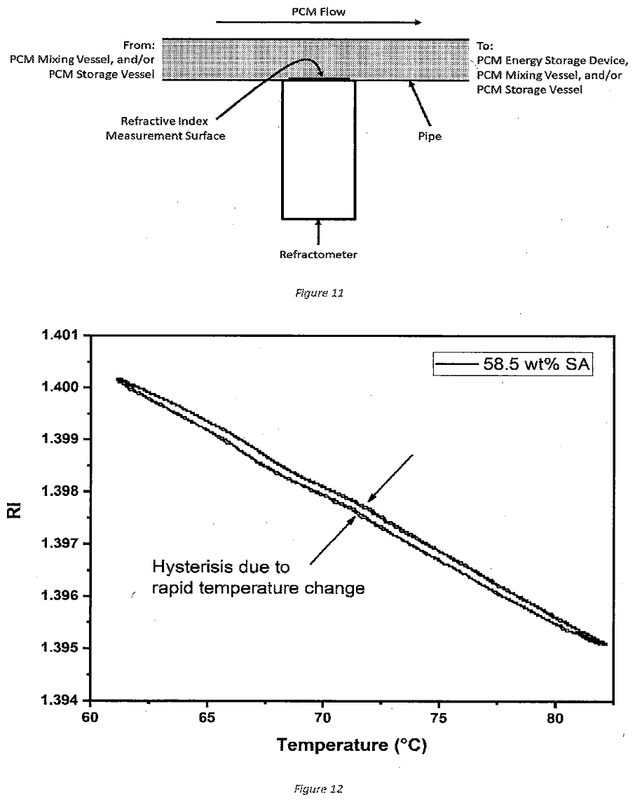

The inlet(s) and/or outlet(s) may be heated and/or cooled to ensure that the PCM remains in its liquid form (i.e. does not crystallise, in the example of sodium acetate trihydrate it is kept above about 58° C. and below about 120° C. to avoid boiling). Heating and cooling may also be used to ensure a liquid PCM flow which has a stable temperature. It has been surprisingly found by the inventors that when the temperature of the PCM changes too rapidly that there is a delay on the RI and/or temperature response of the refractometry apparatus, causing hysteresis on heating and cooling as shown in FIG. 12. Thus, there is a benefit to controlling the temperature of the PCM flowing over the refractive index measurement surface, and a further benefit of ensuring that the temperature change over time is minimised (i.e. the PCM temperature is stable). Insulation of the refractometer apparatus and/or the inlet and/or outlets to the refractive index measurement surface are disclosed as a further means by which this may be achieved. Reducing the temperature differential between the PCM and the surroundings, for example, insulating the pipework through which the PCM travels allows the PCM to be maintained at a constant, homogeneous temperature as it flows over the refractive index measurement surface. Thus, the area around the refractometer may take the form described in FIG. 13, where the inlet(s) and outlet(s) to the refractometer have a heat or cooling jacket and/or are insulated to their surroundings. It is a further benefit of such an apparatus to protect workers from a potentially hot surface, and thus avoid accidental burns.

The homogeneity of temperature of the PCM at the refractive index measurement surface is key. Where heat is highly concentrated and/or is not blended into the bulk of the PCM rapidly, the refractive index becomes inhomogeneous in nature. It has been found by the inventors that inhomogeneous temperatures cause inhomogeneous RI values, which may cause a refractive index measurement which has high errors, is inconsistent, rapidly changes, has noise, or is otherwise uncertain and as such it is a preferred embodiment of the present invention to comprise means to overcome such inhomogeneity.

Trace heating may be used to heat the inlet(s) and/or outlet(s) supplying PCM to the refractive index measurement surface. Herein trace heating is defined as the application of heat over a large surface area. Trace heating may be applied using a resistive element, wire, or network thereof, arranged over the surface of the inlet(s) and/or outlet(s). A heating mat or tape comprising a resistive heating wire in combination in flexible thermal insulation may be used for this purpose.

Such an apparatus may be used to apply heat to one or more of the inlet(s) and/or outlet(s) in an even, homogeneous manner, reducing the likelihood of hotspots forming in the vicinity of the refractive index measurement surface. Thus, trace heating aids in ensuring the homogeneity of the PCM flow temperature, and therefore the reliability of the RI measurement.

The present apparatus comprises means by which heat and/or cooling may be supplied to the inlet(s) and/or outlet(s). An inline heating element and/or thermoelectric device may be used in the PCM flow and/or situated on the external walls of the pipe. It is a preferred embodiment of the present invention that any such heating element and/or thermoelectric device used to heat or cool the PCM is situated on one or more of the outlets, or is situated on the inlet with sufficient distance and/or mixing between the heating or cooling source and the refractometer refractive index measurement surface. This is to avoid inhomogeneity in the temperature of the PCM flow, which causes the refractometer to measure inconsistently, reduces the effective resolution, causes noise and/or causes error in the measurement. Said homogeneity may be achieved using mixing due to the flow of the PCM between the heating/cooling device and the refractometer measurement surface. It is preferred that the temperature of the PCM flow reaching the refractive index measurement surface is homogeneous and changes slowly. Heating and/or cooling may be supplied by one or more heat exchangers in the inlet(s) and/or outlet(s) to the refractometer.

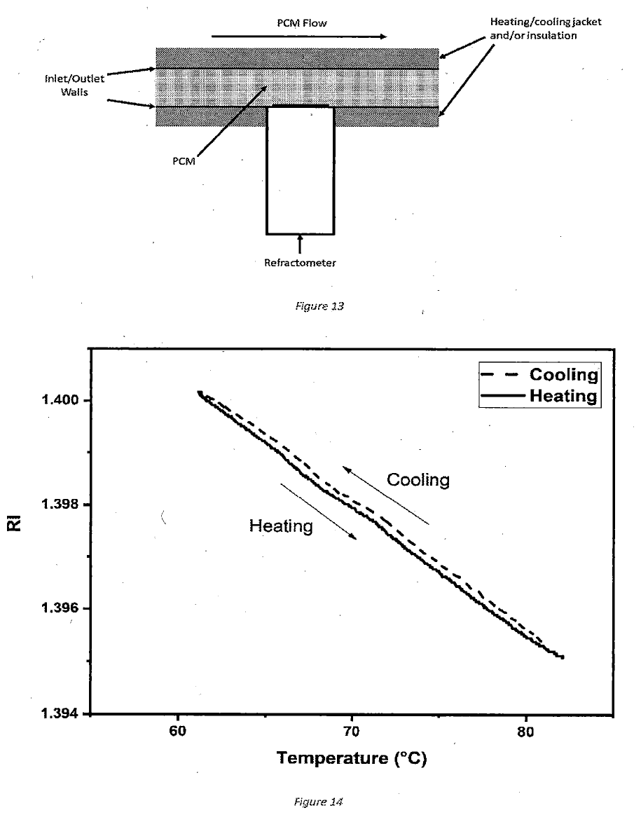

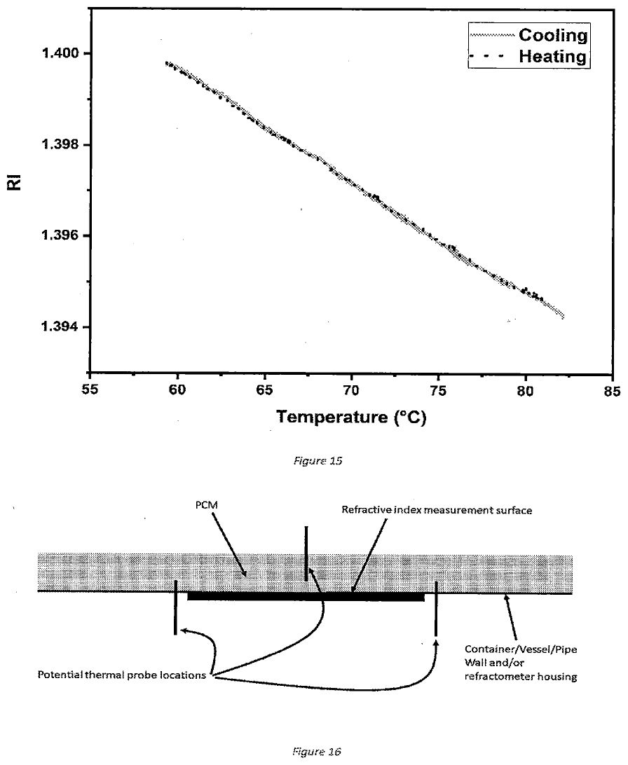

An advantage of the system, apparatus and method of the present invention is that the hysteresis of the refractive index measurement may be less than 0.0005, less than 0.0001 or less than about 0.00005. Hysteresis is defined as the difference in Refractive Index (RI) measured by the refractometer as the temperature of the PCM composition is rising or falling. It has been discovered by the inventors that the refractive index measured may lead or lag the true value on heating and cooling as shown in FIG. 14, particularly where the temperature measurement is taken from a temperature probe which is internal to the refractometer. It has been found by the inventors that slowing the heating and cooling rates has a dramatical effect on the hysteresis of the RI. The heating and cooling rates in FIG. 14 are about 1.2° C. min⁻¹ and 0.5° C. min⁻¹ respectively, with the main hysteresis originating from the rapid heating of the PCM composition. FIG. 15 shows the lack of hysteresis in the same measurement where the heating and cooling rates have been lowered to about 0.3° C. min⁻¹ and 0.07° C. min⁻¹ respectively. It is disclosed herein that hysteresis can be observed where the rate of change of temperature is more than about 0.5° C. min⁻¹. A hysteresis in the RI value measured of more than about 0.00005 may be observable when the rate of change of temperature is more than about 0.5° C. min⁻¹. Greater heating/cooling rates than this are disclosed to result in greater magnitudes of hysteresis.

Thus, it is demonstrated that for accurate concentration measurement of a PCM composition using refractometry any change in temperature of the PCM composition should be less than 1.0° C. min⁻¹, preferably less than 0.5° C. min⁻¹, more preferably less than about 0.3° C. min⁻¹.

Without wishing to be bound by any particular theory, it is suggested that where the temperature rise is too fast, that the temperature measurement may lag behind the true value, causing the RI to lead the true value on heating. This may be caused by a slow response of the thermal probe, or due to rapid thermal transfer via the refractometer housing, particularly around the probe. This effect may be exacerbated by the insulating nature of the molten PCM composition.

In an alternative embodiment, the apparatus of the present invention comprises a further means by which the effect of hysteresis may be obviated or alleviated, by providing a thermal probe in the apparatus located near, or substantially near the refractive index measurement surface. This probe may be situated in the PCM composition which is in close proximity to the refractive index measurement surface.

Preferably, the thermal probe(s) is/are located within about 10 cm of the refractive index measurement surface. More preferably, the thermal probe(s) is/are located within about 5 cm or about 1 cm of the refractive index measurement surface.

FIG. 16 shows potential arrangements, wherein the thermal probe(s) is/are located in the sodium acetate solution.

In a preferred embodiment of the invention, the present apparatus comprises a filter in one or more of the inlets leading to the refractometer. By providing a filter in one or more of the inlets to the refractometer, it is possible filter the PCM flow and remove any small pieces of undissolved PCM components (i.e. solids which have not yet melted or dissolved into the molten PCM bulk) so that undissolved material is kept away from the refractive index measurement surface. This is beneficial as it allows the refractometer to be operated as the PCM composition is adjusted. Undissolved PCM component pieces in the PCM flow may cause an inhomogeneous concentration distribution around the refractometer refractive index measurement surface, and thus causes the refractometer to measure inconsistently, reduces the effective resolution, causes noise and/or causes error in the measurement.

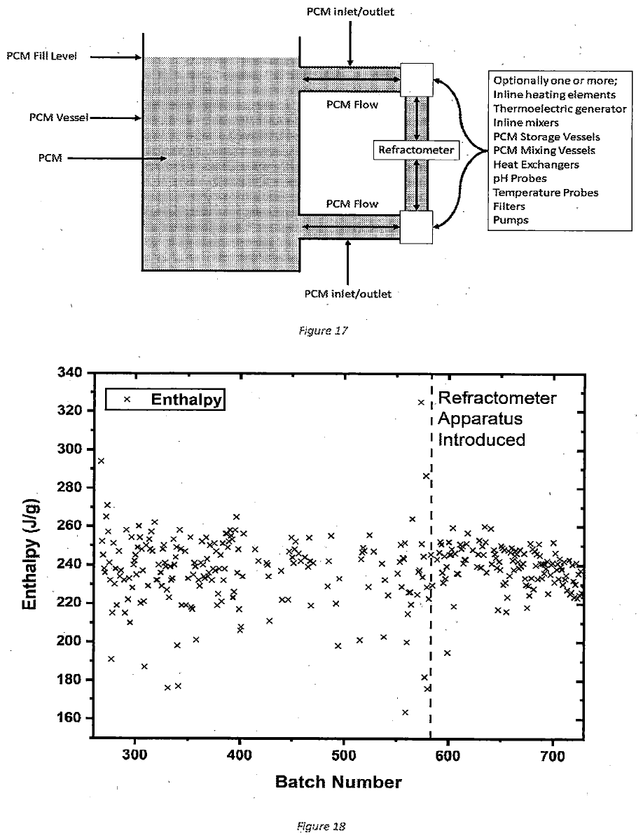

A representation of the various components disclosed as part of the apparatus comprising a refractometer where a single inlet/outlet is used is described in FIG. 17.

In more detail, FIG. 17 shows a PCM vessel for use in the preparation of a PCM, comprising;
One or more PCM inlets arranged on the PCM vessel surface;
One or more PCM outlets arranged on the PCM vessel surface;
A refractometer arranged with the refractive index measurement surface in contact with the PCM flow between the inlet(s) and outlet(s);
means of directing the PCM to flow over the refractometer measurement surface defined between the inlet(s) and outlet(s).

The system of the present invention may also include, as shown in FIG. 17;
One or more means of heating the PCM flowing between the inlet(s) and/or outlet(s).
One or more means of mixing the PCM flow via the inlet(s) and/or outlet(s).
One or more means of measuring the pH of the PCM flow via the inlet(s) and/or outlet(s).
One or more means of flowing (e.g. pumping) the PCM via the inlet(s) and outlet(s) over the refractive index measurement surface.
One or more means of measuring the temperature of the PCM flow via the inlet(s) and/or outlet(s).
And/or
One or more means of insulating the PCM inlet(s) and/or outlet(s).

Herein an inlet is defined as a port via which PCM may move from the PCM vessel to the refractometer.

Herein an outlet is defined as a port via which PCM may move from the refractometer to the PCM vessel.

It is a preferred embodiment of the present invention to heat the PCM flow in the inlet(s) and/or outlet(s) using trace heating, a heat jacket, a hot water jacket, heating coil, fin-tube heat exchanger, plate heat exchanger or other means of heating where the heat is supplied in a homogeneous manner over a large area. Preferably this heating is applied over the entirety of the inlet. More preferably this heating is applied over the entirety of the inlet(s) and outlet(s).

It is a preferred embodiment of the present invention to use an inline heating element to heat the PCM flow down-stream from the refractive index measurement surface.

Herein down-stream is defined as any location in the PCM flow where the PCM is flowing away from the refractive index measurement surface and “up-stream” is therefore defined accordingly.

This is beneficial to the RI measurement as it avoids heat gradients and inhomogeneity of temperature that may be caused by hot spots or hot zones near the element surface. These inhomogeneities of temperature are made homogeneous by the PCM flow.

An inline heating element may be used up-stream of the refractive index measurement surface where the mass flow of the PCM is sufficient to disperse the heat from the heating element to the point of homogeneity.

It is a preferred embodiment of the present invention to use an inline heating element to heat the PCM flow up-stream from the refractive index measurement surface where the PCM is mixed between the inline heating element and the refractive index measurement surface.

The arrangement in FIG. 17 is exemplary only, the inlet(s)/outlet(s) may connect to the PCM vessel in any location on the PCM containment vessel surface. The inlet(s) may be arranged on the PCM vessel walls and/or base. The outlet(s) may be arranged on the walls, base or, if present, lid of the PCM vessel.

The PCM flow in FIG. 17 may be top down, (i.e. the inlet is arranged above the outlet), or bottom up (i.e. the inlet is arranged below the outlet).

Furthermore, the PCM fill level shown in FIG. 17 is exemplary only, the PCM fill level may be any level above the inlet, or above at least one of the inlet(s) that flow the PCM over the refractometer measurement surface.

It is a preferred embodiment of the present invention to arrange at least one inlet below at least one outlet, and to flow the molten PCM via at least one inlet over the refractive index measurement surface and back into the PCM vessel via at least one outlet. It is beneficial to use this “bottom-up” circulation pathway to allow circulation with a lower fill level (i.e. only above the inlet(s), rather than above both inlet and outlet or plurality thereof).

Further to the apparatus described in FIG. 17, the PCM vessel may optionally comprise one or more means of mixing the PCM contained within it.

It is a preferred embodiment of the present invention to insulate the PCM inlet(s) and/or outlets according to FIG. 17.

It is a preferred embodiment of the present invention to provide an apparatus for analysing the composition of a PCM comprising;
A PCM vessel, optionally comprising a mixing device
One or more PCM inlets arranged on the PCM vessel surface
One or more PCM outlets arranged on the PCM vessel surface
A refractometer arranged with the refractive index measurement surface in contact with the PCM flow between the inlet(s) and outlet(s)
A means of flowing the PCM over the refractometer measurement surface via the inlet(s) and outlet(s)
A means of measuring the temperature of the PCM flow in the inlet(s) and/or outlet(s)
A means of heating the PCM inlet(s) and/or outlet(s)
A means of insulating the PCM inlet(s) and/or outlet(s)
Wherein;
The PCM inlet(s) is/are arranged below the PCM fill level and optionally below the outlet(s).

The PCM is flowed from the PCM vessel via the inlet over the refractive index measurement surface and via the outlet back into the PCM vessel.

Heat is applied homogeneously over the surface of the inlet(s) and optionally the outlet(s)

It should be noted that the geometry, sizes, arrangement, flow directions and inlet/outlet locations given herein is purely exemplary. It is clear to those skilled in the art that variations of the layout of the apparatus disclosed herein will result in a working apparatus for the analysis of molten PCM solutions. For example, the PCM fill level may be lower than one or more outlets, as the apparatus will operate so long as at least one inlet has access to the solution. Furthermore, it should be understood that the flow direction of the PCM solution may be changed, altering the identity of the inlets/outlets in the supplied diagrams.

Alterations to the PCM composition may be made, using the apparatus, system and method described herein, by addition of quantities of the PCM components to achieve the predetermined component concentration indicated by the corresponding refractive index at the temperature measured. Using additions of around 0.05 wt. % or 0.01 wt. %, operators can achieve a particular formulation of PCM to within less than 0.5 wt. % of a predetermined value of composition e.g. wt % salt in water, or preferably less than 0.1 wt. % salt in water. Operators may make the addition of the PCM components to the molten PCM and gain a resulting change in RI almost immediately. The speed at which a result is returned by the apparatus, system and method as described herein is dependent largely on the mixing and flow characteristics to which the PCM is subjected. A combination of mixing, including shear mixing, and pumped flow over the refractive index measurement surface has been found by the inventors to be the preferred solution, giving the quickest response in RI to changes in PCM formulation.

According to a further aspect of the present invention is disclosed a method of use of an apparatus as disclosed herein, wherein the composition of the PCM is adjusted by one or more of the means selected from the following group:
Addition of an anhydrous salt;
Addition of a salt hydrate;
Addition of an organic PCM component; and
Addition or removal of water,
And is homogenised by one or more of the means selected from the following group:
Mixing of the PCM in a PCM reservoir;
Flowing the PCM through the one or more PCM inlet(s) and/or outlet(s); and
Heating the PCM,
Until the PCM is fully homogenised and the refractive index of the PCM ceases to change independently of temperature.

Changes to the PCM composition by addition or removal of PCM components cause the RI value to change independently of the temperature. For example, addition of a component may cause the RI value to rise while the temperature remains constant-the RI has changed independently of temperature. However, if the temperature of the PCM changes, for example due to heating or cooling of the apparatus, the RI value will change depending on temperature. A measurement of RI may be taken in the disclosed method at a point where the RI has ceased to change independently of temperature-i.e. the changes in RI can be solely proscribed to changes in temperature. This indicates the point that the PCM component being added or removed from the PCM has fully incorporated, melted, dissolved or otherwise homogenised into the PCM mixture. The above process steps may be carried out one or more times, until the refractive index of the PCM corresponds to the predetermined composition of the PCM at the same temperature as the measurement temperature above the melting point of the PCM. In other words, the refractive index and temperature data (i.e. the measurement temperature) is compared to known data and then adjustments are made accordingly. For example, if a measured RI value is lower at a certain measurement temperature compared to known calibration data for RI at that same measurement temperature, then PCM components may be added and/or removed to increase the RI value against the measurement temperature in order to achieve the desired PCM composition comprising appropriate PCM components.

Determination of the temperature dependence of RI for a certain composition of PCM components is achieved by calibration, i.e. measurement of the RI response vs temperature for a known composition. Thus, an unknown composition can be compared to one or more sets of calibration data and adjustments made according to such to achieve a predetermined PCM composition.

A predetermined PCM composition may be the PCM composition that may be used without any further changes to its composition, it is the desired PCM composition. A predetermined PCM composition may also be an intermediate composition which is prepared as part of the PCM preparation process. Any predetermined PCM composition must have a known relationship between its refractive index and temperature, such that comparisons and adjustments may be made using the apparatus, systems and methods as disclosed herein. This relationship between refractive index and temperature may be generated using the apparatus, systems and methods disclosed herein, by inputting a known PCM composition and measuring the change of refractive index against temperature.

Hence the apparatus may be used to confirm the prepared PCMs composition (i.e. checking that the RI at the measurement temperature matches the calibration RI at the same measurement temperature), but also be used to make any necessary adjustments, which may be done in one or more steps or repetitions of the method.

Water may be removed by heating, desiccation, or combination thereof or by other known methods for removal of water.

The apparatus may be used as part of a system including a method for adjusting the composition of the PCM comprising one or more of the following steps:
Adding an anhydrous salt,
Adding a salt hydrate,
Adding an organic PCM, and/or
Adding or removing water,
And homogenising by one or more of the following steps:
Mixing of the PCM,
Flowing the PCM through the one or more PCM inlet(s) and/or outlet(s), and/or
Heating the PCM,
Until;
The PCM is fully homogenised, and
The refractive index of the PCM ceases to change independently of temperature;
And then comparing the measured refractive index to the refractive index of the predetermined composition of the PCM at the same temperature as the measurement temperature,
and optionally repeating the above steps until the refractive index of the PCM corresponds to the predetermined composition of the PCM at the same temperature as the measurement temperature. The amounts of each PCM component in the PCM composition may be adjusted as set out in the above steps until the refractive index of the PCM matches the refractive index of the predetermined composition of the PCM to within less than 1 wt. %, preferably less than 0.5 wt. %, more preferably less than 0.1 wt. % of each PCM component, wherein the measurement and predetermined composition refractive indices are compared at the same temperature.

The process of adjustment of a PCM composition by addition and/or removal of one or more PCM components according to its RI and temperature data using comparison to a known predetermined PCM compositions RI data wherein the measurement and predetermined composition refractive indices are compared at the same temperature, is shown schematically in FIG. 19. Therein a PCM composition being usable may mean the PCM is of a suitable composition to be applied for use as a PMC composition; or may mean that the PCM composition is of a suitable composition to continue to the next step of the preparation process. A specific window of RI according to FIG. 19 may be defined as a window of RI which is deemed to be acceptably close to the predetermined PCM composition as to not cause any deleterious effects on the PCM performance. The RI window as shown in FIG. 19 may correspond to a PCM composition which is within less than 1 wt. %, preferably less than 0.5 wt. %, more preferably less than 0.1 wt. % of each PCM component from the predetermined PCM composition, wherein the measurement refractive index and predetermined composition window refractive index are compared at the same temperature.

The PCM components used to make the adjustment may be added or removed in amounts corresponding to about 0.01 wt. %, 0.05 wt. %, 0.1 wt. %, 0.5 wt. % or 1 wt. % of the whole PCM bulk. Preferably the adjustments made may be made by addition or removal of about 0.01 wt. % or 0.05 wt. % of the PCM bulk.

The PCM components, which may be anhydrous salts, salt hydrates, organic PCM components and/or water may be added individually and fully homogenised, dissolved and/or melted before RI measurement and any further adjustment necessary. In other words, adjustments may be made using a single component at a time.

Where a PCM comprises more than two components that must be tuned to specific values, changes to the composition using the apparatus disclosed herein may be made in stages, such that only one component is being added to removed at any point during the use of the apparatus. This is to ensure that adjustments are made to known calibrations.

Where the PCM is comprised of more than two components the method comprises;
Forming of a homogeneous mixture of the components,
Adjusting the relative amounts the two or more components relative to one another (i.e. by addition and/or removal of one or more of the components), until the refractive index of the PCM matches the refractive index of the predetermined composition of the PCM and wherein the measurement and predetermined composition refractive indices are compared at the same temperature.

Forming a homogeneous mixture of the adjusted mixture of the first two components and a third component;
Adjusting the third component (i.e. by addition and/or removal of the third component) Until the refractive index of the PCM matches the refractive index of the predetermined composition of the PCM and wherein the measurement and predetermined composition refractive indices are compared at the same temperature;
And optionally repeating this process for any further components.

In this way, a PCM comprising more than two components may be accurately prepared to a predetermined PCM composition.

By way of non-limiting example, a PCM comprising sodium acetate, sodium nitrate and water may be considered. Here, an accurately known final composition may be prepared as follows:
Formation of a homogeneous mixture of water and sodium acetate and maintaining the temperature above about 58° C. to avoid crystallisation of sodium acetate trihydrate,
Adjustment of sodium acetate: water ratio by addition of sodium acetate and/or removal of water
Addition of sodium nitrate to approximately the predetermined amount
Adjustment of the sodium nitrate by addition of sodium nitrate

By way of further non-limiting example, a set of RI vs temperature data was generated for PCMs comprising calcium nitrate and water to be used as pre-determined calibration data for unknown PCMs comprising calcium nitrate and water.

This was achieved by preparing known solutions of calcium nitrate in water between about 50 wt. % and 70 wt. % and measuring, using the apparatus as disclosed herein, the changes in refractive index as the temperature was varied between about 45 and 65° C. The results of this calibration analysis is shown in Table 5

TABLE 5

| Calcium nitrate content | Temperature | |
|---|---|---|
| (wt. % in water) | (° C.) | RI |
| 50 | 40 | 1.42064 |
| | 45 | 1.41932 |
| | 50 | 1.41802 |
| | 55 | 1.41702 |
| | 60 | 1.41590 |
| | 65 | 1.41476 |
| 55 | 40 | 1.42943 |
| | 45 | 1.42824 |
| | 50 | 1.42689 |
| | 55 | 1.42569 |
| | 60 | 1.42441 |
| | 65 | 1.42337 |
| 60 | 40 | 1.43980 |
| | 45 | 1.43861 |
| | 50 | 1.43737 |
| | 55 | 1.43780 |
| | 60 | 1.43682 |
| | 65 | 1.43587 |
| 65 | 40 | 1.45441 |
| | 45 | 1.45328 |
| | 50 | 1.45232 |
| | 55 | 1.45115 |
| | 60 | 1.44999 |
| | 65 | 1.44870 |
| 70 | 45 | 1.46531 |
| | 50 | 1.46420 |
| | 55 | 1.46309 |
| | 60 | 1.46197 |
| | 65 | 1.46086 |
| 75 | 45 | 1.47587 |
| | 50 | 1.47478 |
| | 55 | 1.47371 |
| | 60 | 1.47266 |
| | 65 | 1.47145 |

Thus, a set of predetermined RI calibration data for various concentrations of calcium nitrate in water over various temperatures was generated. Interpolation of the data shown in Table 5 allows the extraction of formulae which describe the RI response of various calcium nitrate based PCMs at various temperatures which are relevant to their preparation (i.e. are molten). Thus, the response of RI to both temperature and wt. % calcium nitrate of calcium nitrate based PCMs can be quantified. In other words, when analysing an unknown or inaccurately known composition of calcium nitrate in water, changes of RI due to changes in temperature and calcium nitrate/water ratio can be accounted for.

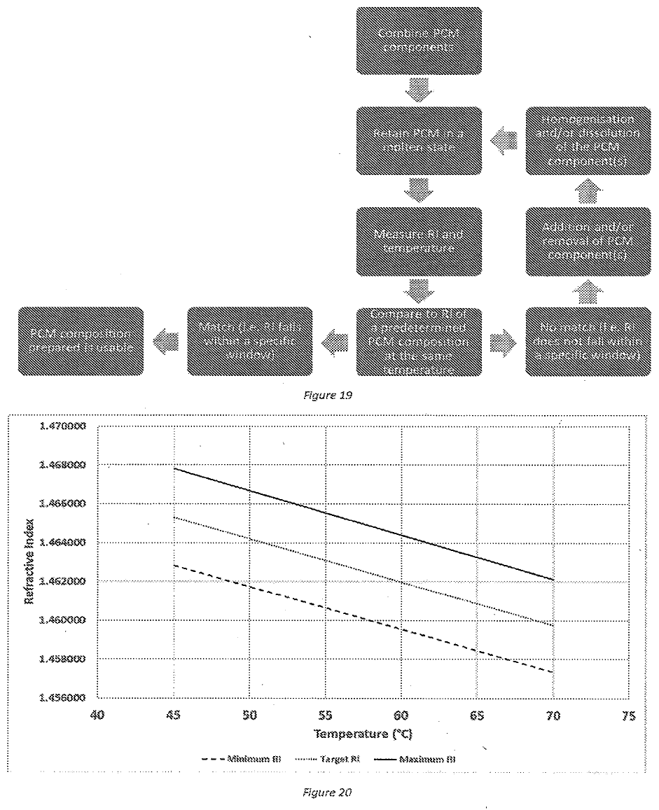

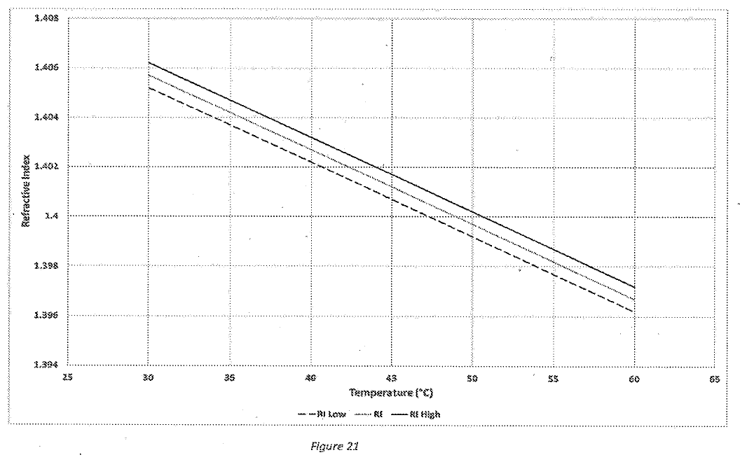

Taking the further example of the tetrahydrate form of calcium nitrate (approx. 70 wt. % calcium nitrate in water), calibration data from table 5 can be used to derive acceptable windows of RI. Upper and lower windows of RI at different temperatures were derived according to less than 0.5 wt. % of calcium nitrate in water. The example calibration graph showing said windows of RI is given in FIG. 20.

When preparing a PCM comprised of calcium nitrate and water, where the composition required is about 70 wt. % calcium nitrate in water, a combination of calcium nitrate and water is firstly made.

The composition of this combination is initially unknown, or may be known, but to a low degree of accuracy. Once this composition is in a fully molten and homogeneous state, the RI of the composition and temperature of the composition is measured. Comparing the RI at the temperature measured to the corresponding RI data in FIG. 20 adjustments may then be made to bring the RI, and therefore the composition, into the window of acceptable compositions as defined by the calibration data shown in FIG. 20. If, for example, the RI falls below the lower limit of the acceptable RI window in FIG. 20 (i.e. the dashed line) then the RI may be increased by addition of calcium nitrate and/or removal of water. If, for example, the RI is above the upper limit of the acceptable RI window in FIG. 20 (i.e. the solid line) then the RI may be reduced by addition of water and/or removal of calcium nitrate. Thus, the composition may be adjusted to a predetermined composition according to the calibration data from the predetermined calcium nitrate-water PCM composition. This composition (about 70 wt. % calcium nitrate in water) may then be used as a PCM, or have further materials added to it, for example further salts and/or salt hydrates which may be used to depress the melting point of the PCM, act as nucleation agents and/or stabilise the PCM.

By way of further non-limiting example, a calibration process may be carried out for PCM compositions comprising tetrabutylammonium hydroxide and water. Refractive index data measured against temperature of a predetermined composition of 40 wt. % tetrabutylammonium hydroxide in water is shown in FIG. 21. In FIG. 21, acceptable windows of RI, which correspond to acceptable windows of tetrabutylammonium hydroxide content (e.g. less than about 0.5 wt. %) are shown, with the upper limit of tetrabutylammonium hydroxide shown as the full line in FIG. 21 and the lower limit of tetrabutylammonium hydroxide content shown as a dashed line. Thus, where a PCM which comprises a 40 wt. % solution of tetrabutylammonium hydroxide is required, such data may be used to ensure the preparation is of an acceptable composition (i.e. its RI falls within the solid and dashed RI lines in FIG. 21). To prepare a PCM composition comprising a 40 wt. % solution of tetrabutylammonium hydroxide, an unknown or inaccurately known composition of tetrabutylammonium hydroxide in water may firstly be prepared, homogenised and made molten. Analysis of this unknown molten composition with the apparatus as disclosed herein results in a refractive index measured at a certain temperature which can be compared to the RI data of the predetermined 40 wt. % composition shown in FIG. 21 at the same temperature. If, for example, the RI falls below the lower limit of the acceptable RI window in FIG. 21 (i.e. the dashed line) then the RI may be increased by addition of tetrabutylammonium hydroxide and/or removal of water. If, for example, the RI is above the upper limit of the acceptable RI window in FIG. 21 (i.e. the solid line) then the RI may be reduced by addition of water and/or removal of tetrabutylammonium hydroxide. Thus, the composition may be adjusted to a predetermined composition according to the calibration data. Once adjustments have been made, further modifications may be made to the PCM, including addition of further PCM components, additives or adjuvants.

By way of further non-limiting example, a calibration process may be carried out for PCM compositions comprising sodium nitrate and water. Various known compositions of sodium nitrate from 0.5 wt. % to 40 wt. % were prepared, homogenised and retained in a molten state at 20° C. These compositions were the predetermined compositions which were used for the provision of calibration data for PCM compositions comprising sodium nitrate and water. Their refractive indices were then measured using the apparatus as disclosed herein, giving the data shown in Table 6.

TABLE 6

| Sodium nitrate content | RI at |
|---|---|
| (wt. % in water) | 20° C. |
| 0.5 | 1.3336 |
| 1 | 1.3341 |
| 2 | 1.3353 |
| 3 | 1.3364 |
| 4 | 1.3375 |
| 5 | 1.3387 |
| 6 | 1.3398 |
| 7 | 1.3409 |
| 8 | 1.3421 |
| 9 | 1.3432 |
| 10 | 1.3443 |
| 12 | 1.3466 |
| 14 | 1.3489 |
| 18 | 1.3536 |
| 20 | 1.3559 |
| 30 | 1.3678 |
| 40 | 1.3802 |

Thus, PCM compositions comprising sodium nitrate in water may be analysed according to the RI of predetermined compositions between 0.5 and 40 wt. % sodium nitrate in water shown in Table 6, where the PCM is held at a temperature of 20° C. Acceptable composition windows which correspond to acceptable RI windows can be extracted from such data as is shown in Table 6 as follows:
Extracting the linear relationship (i.e. equation of the straight line) that links refractive index and sodium nitrate content
Calculating the difference in RI between two values which correspond to upper and lower limits (i.e. 1 wt. %, 0.5 wt. %, 0.1 wt. % or less).

These upper and lower limits may then be tabulated or plotted graphically. For example, tabulation of various options for acceptable RI windows for the data shown in Table 6 is given in Table 7.

TABLE 7

| Sodium | 1 wt. % | 0.5 | | | 0.1 | 0.5 | |
|---|---|---|---|---|---|---|---|
| nitrate | lower | wt. % | 0.1 wt. % | | wt. % | wt. % | 1 wt. % |
| content | limit | lower | lower | Ideal | upper | upper | upper |
| (wt. % in | RI at | limit RI | limit RI | RI at | limit RI | limit RI | limit RI |
| water) | 20° C. | at 20° C. | at 20° C. | 20° C. | at 20° C. | at 20° C. | at 20° C. |
| 0.5 | 1.3324 | 1.3330 | 1.3335 | 1.3336 | 1.3337 | 1.3342 | 1.3348 |
| 1 | 1.3329 | 1.3335 | 1.3340 | 1.3341 | 1.3342 | 1.3347 | 1.3353 |
| 2 | 1.3341 | 1.3347 | 1.3352 | 1.3353 | 1.3354 | 1.3359 | 1.3365 |
| 3 | 1.3352 | 1.3358 | 1.3363 | 1.3364 | 1.3365 | 1.3370 | 1.3376 |
| 4 | 1.3363 | 1.3369 | 1.3374 | 1.3375 | 1.3376 | 1.3381 | 1.3387 |
| 5 | 1.3375 | 1.3381 | 1.3386 | 1.3387 | 1.3388 | 1.3393 | 1.3399 |
| 6 | 1.3386 | 1.3392 | 1.3397 | 1.3398 | 1.3399 | 1.3404 | 1.3410 |
| 7 | 1.3397 | 1.3403 | 1.3408 | 1.3409 | 1.3410 | 1.3415 | 1.3421 |
| 8 | 1.3409 | 1.3415 | 1.3420 | 1.3421 | 1.3422 | 1.3427 | 1.3433 |
| 9 | 1.3420 | 1.3426 | 1.3431 | 1.3432 | 1.3433 | 1.3438 | 1.3444 |
| 10 | 1.3431 | 1.3437 | 1.3442 | 1.3443 | 1.3444 | 1.3449 | 1.3455 |
| 12 | 1.3454 | 1.3460 | 1.3465 | 1.3466 | 1.3467 | 1.3472 | 1.3478 |
| 14 | 1.3477 | 1.3483 | 1.3488 | 1.3489 | 1.3490 | 1.3495 | 1.3501 |
| 18 | 1.3524 | 1.3530 | 1.3535 | 1.3536 | 1.3537 | 1.3542 | 1.3548 |
| 20 | 1.3547 | 1.3553 | 1.3558 | 1.3559 | 1.3560 | 1.3565 | 1.3571 |
| 30 | 1.3666 | 1.3672 | 1.3677 | 1.3678 | 1.3679 | 1.3684 | 1.3690 |
| 40 | 1.3790 | 1.3796 | 1.3801 | 1.3802 | 1.3803 | 1.3808 | 1.3814 |

Thus acceptable compositional windows can be ascribed to windows of RI. Selecting a desired accuracy of the preparation, for example to within 1 wt. %, to within 0.5 wt. % or to within 0.1 wt. % as per Table 7, preparation of PCM compositions comprising sodium nitrate and water may be carried out using RI as a means of determination of the composition to within the desired accuracy.

For a PCM preparation where the preparation temperature is variable, tables and/or graphs of data such as that shown as an example in Table 7 may be produced at various different temperatures, and as such calibration of predetermined compositions may be acquired across any combination of component content and temperature. Thus, full calibration data sets can be generated for use with the apparatus disclosed in the present invention.

By way of non-limiting example wherein the PCM composition temperature is retained at a set value (in this case 20° C.), a PCM composition comprising 18 wt. % sodium nitrate in water may be analysed as follows. An unknown or inaccurately known composition of a PCM comprising sodium nitrate and water may be prepared by combination of sodium nitrate and water, made homogeneous and molten while retaining the temperature at 20° C. This composition may be analysed using the apparatus as disclosed herein, and a RI value at 20° C. determined. Comparing the RI at 20° C. to the corresponding RI data in Table 7 adjustments may then be made to bring the RI, and therefore the composition, into the window of acceptable compositions as defined by the calibration data shown in Table 7. If, for example, the RI falls below the lower limit of the acceptable RI window in Table 7 (i.e. is less than 1.3524, 1.3530, or 1.3535 depending on the accuracy desired) then the RI may be increased by addition of sodium nitrate and/or removal of water. If, for example, the RI is above the upper limit of the acceptable RI window in Table 7 (i.e. is greater than 1.3537, 1.3542 or 1.3548 depending on the accuracy required) then the RI may be reduced by addition of water and/or removal of sodium nitrate. Thus adjustments to the composition may be made according to the desired accuracy of the preparation.

It is important to note that the examples shown are merely exemplary, and it is to be understood that any range of temperature and PCM component content may be used and analysed using the apparatus and method of the present invention, provided that the PCM is in a molten state.

It is a preferred embodiment of the present invention that the apparatus comprises a mixing tank fitted with a method of mixing, including shear mixing, where the refractive index measurement surface is situated in a secondary pipe fed by one or more feeds from the mixing tank with the output being returned to the mixing tank, and one or more pumps providing flow over the refractive index measurement surface.

By using the apparatus and method of the present invention, it has been surprisingly discovered by the inventors that the reproducibility, accuracy and precision of preparations comprising a sodium acetate solution of about 58 wt. % sodium acetate may be improved, and thereby the thermal performance of the materials is improved. FIG. 18 shows an analysis of thermal energy storage capacity of materials prepared before and after the installation of an apparatus of the present invention. There is a general reduction in the variability (i.e. the spread) of energy storage capacity values for the materials after the refractometer apparatus was installed, with particular reductions in the incidence of very low energy storage capacity (i.e. below 200 J/g). Thus, the apparatus has a significant positive impact on the reliability of the production process of PCMs, and in doing so increases the average energy density of the material by removing the potential for low outliers. The improvement of the batch variability is given in Table 8.

TABLE 8
Performance improvement due to the refractometer
apparatus of the present invention

| | Mean | Median | Standard |
|---|---|---|---|
| | Latent Heat | Latent Heat | Deviation |
| | (J g⁻¹) | (J g⁻¹) | (J g⁻¹) |
| Before Apparatus | 234 | 239 | 31 |
| Introduction | | | |
| After Apparatus | 238 | 241 | 23 |
| Introduction | | | |

Increases in the mean latent heat, median latent heat can be observed, and a reduction in the standard deviation indicating a reduction in spread of values and therefore a more consistent process. Thus the positive effect on the production of PCMs and devices comprising PCMs of using an apparatus as disclosed herein is demonstrated.

It is to be understood that the present invention is not limited to the specific embodiments described herein which are given by way of example only.

1. An apparatus for determining the composition of a molten Phase change material (PCM), the PCM comprising any one or more of the following group:
one or more anhydrous salts, each being present in a concentration of at least 1 wt. % of the PCM;
an aqueous solution of between about 1 wt. % and 75 wt. % of one or more anhydrous salts; and
water; or
one or more organic phase change materials, each being present in the PCM in a concentration of at least 1 wt. % of the PCM;
wherein the apparatus comprises:
means for maintaining the PCM in a molten state;
a reservoir for holding the molten PCM; and
at least one refractometer having a refractive index measurement surface and the refractometer being configured for measuring refractive index of the molten PCM:
at least one means for measuring the temperature of the molten PCM;
and wherein the reservoir is in contact with or in fluid communication with the refractive index measurement surface whereby, in use, the refractometer measures the refractive index of the molten PCM; configured to flow over the refractive index measurement surface;
wherein the apparatus comprises at least one PCM inlet for enabling molten PCM to flow to the refractive index measurement surface; and
the apparatus comprising at least one PCM outlet for enabling molten PCM to flow away from the refractive index measurement surface;
wherein the apparatus is adapted for obtaining a measurement of the refractive index of the molten PCM by flowing the molten PCM over the surface of the reactive index measurement surface; and
wherein the apparatus is adapted for comparing the measurement of the refractive index of the molten PCM to data comprising refractive index measurements of known compositions and adapted for determining the composition of the molten PCM from the comparison data.

2. An apparatus as claimed in claim 1 wherein the refractometer is configured with the refractive index measurement surface in contact with the PCM flowing between the inlet(s) and outlet(s).

3. An apparatus as claimed in claim 1 further comprising means of directing the PCM to flow over the refractometer measurement surface defined between the at least one inlet and the at least one outlet.

4. An apparatus as claimed in claim 1 further comprising means of heating the PCM flowing between the at least one inlet and the at least one outlet.

5. An apparatus as claimed in claim 1 further comprising means of mixing the PCM flow between the at least one inlet and the at least one outlet.

6. An apparatus as claimed in claim 1 further comprising means of measuring the pH of the PCM flowing between the at least one inlet and the at least one outlet.

7. (canceled)

8. An apparatus as claimed in claim 1 further comprising at least one means of measuring the temperature of the PCM flow via the inlet(s) and/or outlet(s).

9. An apparatus as claimed in claim 1 further comprising one or more means of insulating the at least one inlet(s) and/or the at least one outlet(s) of the reservoir.

10. (canceled)

11. An apparatus as claimed in claim 1 wherein the means for measuring temperature of the molten PCM comprises a temperature probe configured to be in contact with the molten PCM.

12. An apparatus according to claim 1, wherein the apparatus is configured to determine the composition of a molten Phase Change Material (PCM), wherein the apparatus is configured to measure the refractive index of the PCM in the range of between about 1.300 and 1.700 with a resolution of at least 0.001.

13. An apparatus according to claim 1 wherein the apparatus is configured to allow addition and/or removal of PCM components to/from the PCM reservoir such that the concentration of one or more salts between 3 wt. % and 75 wt. % is adjustable to a value to within less than 1 wt. %, preferably less than 0.5 wt. %, more preferably less than 0.1 wt. % of a predetermined value.

14. An apparatus according to claim 1, wherein the apparatus is configured to allow addition and/or removal of PCM components to/from the PCM reservoir such that the ratio of a plurality of anhydrous salts is adjustable to a value between about 1 wt. % and 99 wt. % and to within less than 1 wt. %, preferably less than 0.5 wt. %, more preferably less than ±0.1 wt. % of a predetermined value.

15. An apparatus according to claim 1, wherein the apparatus is configured to allow addition and/or removal of PCM components to/from the PCM reservoir such that the ratio of a plurality of organic PCMs is adjustable to a d value between about 1 wt. % and 99 wt. % to within less than 1 wt. %, preferably less than 0.5 wt. %, more preferably less than 0.1 wt. % of a predetermined value.

16. An apparatus according to claim 1 wherein the PCM comprises:
between about 40 wt. % and 75 wt. % of one or more salts, and
Water.

17. An apparatus according to claim 1, wherein the salt(s) is/are selected from a list comprised of;
Sodium acetate;
Sodium sulfate;
Calcium nitrate;
Magnesium nitrate;
Sodium nitrate;
Lithium nitrate;
Calcium chloride;
Calcium bromide;
Strontium chloride; and/or
Strontium bromide.

18. An apparatus according to claim 1, wherein the or each refractometer has a resolution of at least 0.001, 0.0005 or 0.0001.

19. An apparatus according to claim 1, wherein the or each refractometer comprises a refractive index measurement surface and at least one temperature probe is located near or substantially near the surface of the refractive index measurement surface.

20. An apparatus according to claim 1, wherein one or more temperature probe is situated in the PCM solution near or substantially near the refractive index measurement surface.

21. An apparatus according to claim 1, wherein at least one temperature probe is located in the PCM less than 10 cm, less than 5 cm, or less than 1 cm from the refractive index measurement surface.

22. An apparatus according to claim 1, wherein the temperature of the PCM changes by less than 1.0° C. min⁻¹, less than 0.5° C. min⁻¹ or less than 0.3° C. min⁻¹ during measurement.

23. An apparatus according to claim 1, wherein one or more of the inlets and/or outlets comprises any one or more of the following:
One or more means for heating and/or cooling PCM flow;
One or more means for thermally insulating the PCM flow;
One or more means for mixing the PCM flow; and
One or more means for filtering the PCM flow.

24. (canceled)

25. (canceled)

26. (canceled)

27. (canceled)

28. An apparatus according to claim 1, wherein the apparatus is configured to limit the rise or fall in temperature of the PCM to less than ±1.0° C. min⁻¹, less than ±0.5° C. min⁻¹ or less than ±0.3° C. min⁻¹ during measurement.

29. An apparatus according to claim 1, for determining the composition of a molten PCM solution comprising:
between about 50 wt. % and 65 wt. % sodium acetate, and
Water;
wherein the apparatus comprises:
means for maintaining the solution at a temperature greater than about 58° C.,
One or more refractometers configured to measure refractive index in the range of between about 1.390 and 1.41 with a resolution of at least 0.001; and
One or more temperature probes, wherein at least one temperature probe measures the temperature of the sodium acetate solution;
One or more means by which the PCM is configured to flow over the refractive index measurement surface; and
Wherein the apparatus is used to adjust the sodium acetate concentration to a value between 50 wt. % and 65 wt. % and to within less than 1 wt. %, preferably less than 0.5 wt. %, more preferably less than 0.1 wt. % of a predetermined value.

30. (canceled)

31. A method for determining the composition of a molten Phase change material (PCM) using a refractive index measuring apparatus, the PCM comprising any one or more of the following group:
one or more anhydrous salts, each with a concentration of at least 1 wt. %,
an aqueous solution of between about 1 wt. % and 75 wt. % of one or more anhydrous salts; and
water;
or
one or more organic phase change materials, each in a concentration of at least 1 wt. % of the total PCM composition;
wherein the apparatus comprises
means for maintaining the PCM in a molten state;
a reservoir for holding the molten PCM; and
at least one refractometer having a refractive index measurement surface and the refractometer being configured for measuring refractive index of the molten PCM;
at least one means for measuring the temperature the temperature of the molten PCM;
and wherein the reservoir is in fluid communication with the refractive index measurement surface whereby the refractometer measures the refractive index of the molten PCM;
wherein the method comprises;
providing the PCM in a molten state, and
providing fluid contact between the PCM and the refractive index measurement surface; and
providing the reservoir with at least one PCM inlet for enabling PCM to flow to the refractive index measurement surface; and
providing at least one PCM outlet for enabling PCM to flow away from the refractive index measurement surface; and
obtaining a measurement of the refractive index of the molten PCM by flowing the molten PCM over the surface of the refractive index measurement surface; and
comparing the measurement of the refractive index of the molten PCM to data comprising refractive index measurements of known compositions and determining the composition of the molten PCM from the comparison data.

32. A method according to claim 31, wherein the method also comprises adjusting the composition of the PCM by one or more of the following means:
adding an anhydrous salt,
adding a salt hydrate,
adding an organic PCM, and/or
adding or removing water,
until the refractive index of the PCM matches the refractive index of the predetermined composition of the PCM and wherein the measurement and predetermined composition refractive indices are compared at the same temperature.

33. A method according to claim 31, wherein the method also comprises adjusting the composition of the PCM by one or more of the following means:
Addition of an anhydrous salt,
Addition of a salt hydrate,
Addition of an organic PCM, and/or
Addition or removal of water
until the refractive index of the PCM matches the refractive index of the predetermined composition of the PCM to within less than 1 wt. %, preferably less than 0.5 wt. %, more preferably less than 0.1 wt. % of each PCM component, wherein the measurement and predetermined composition refractive indices are compared at the same temperature.

34. A method according to claim 31, wherein the method also comprises adjusting the composition of the PCM by one or more of the following means:
Addition of an anhydrous salt;
Addition of a salt hydrate;
Addition of an organic PCM; and/or
Addition or removal of water;
And is homogenised by one or more of the following means:
Mixing of the PCM;
Flowing the PCM through the one or more PCM inlet(s) and/or outlet(s); and/or
Heating the PCM;
until;
the PCM is fully homogenised, and
the refractive index of the PCM ceases to change independently of temperature.
and comparing the measured refractive index to the refractive index of the predetermined composition of the PCM wherein the measurement and predetermined composition refractive indices are compared at the same temperature;
and optionally repeating the above steps until the refractive index of the PCM matches the refractive index of the predetermined composition of the PCM and wherein the measurement and predetermined composition refractive indices are compared at the same temperature.

35. A method according to claim 33 wherein the composition adjustments comprise addition or removal of materials in amounts of less than about 1 wt. %, less than 0.5 wt. %, less than 0.2 wt. %, less than 0.1 wt. %, less than 0.05 wt. % or less than 0.01 wt. % of the total PCM composition before measuring the refractive index.

36. A method according to claim 32 wherein the PCM is comprised of more than two components, wherein one component may be water and wherein the method of adjusting the PCM composition comprises:
forming a homogeneous mixture of two of the components;
adjusting the amounts of each of the two components relative to one another by addition and/or removal of one or both of the components until the refractive index of the PCM matches the refractive index of the predetermined composition of the PCM and wherein the refractive index of the measurement and predetermined composition refractive indices are compared at the same temperature;
forming a homogeneous mixture of the adjusted mixture of the first two components and the third component;
adjusting the third component relative to the mixture of the first two components by addition and/or removal of the third component until the refractive index of the PCM matches the refractive index of the predetermined composition of the PCM and wherein the measurement and predetermined composition refractive indices are compared at the same temperature;
and optionally repeating this process for any further components.
